(19) United States
(12) Patent Application Publication
(10) Pub. No.: US 2025/0174724 A1
(43) Pub. Date: May 29, 2025

(54) NON-CORROSIVE LIQUID ELECTROLYTE FOR RECHARGEABLE MULTIVALENT BATTERIES AND METHODS OF MAKING THE SAME

(71) Applicant: Revolution Power Inc., Seattle, WA (US)

(72) Inventors: Yujia Liang, Bellevue, WA (US); Chao Luo, Coral Gables, FL (US); David Shock, Bainbridge Island, WA (US); Jinghao Huang, Fairfax, VA (US); Motahareh Mohammadiroudbari, Centreville, VA (US)

(21) Appl. No.: 18/960,889

(22) Filed: Nov. 26, 2024

Related U.S. Application Data
(60) Provisional application No. 63/604,072, filed on Nov. 29, 2023.

(51) Int. Cl. H01M 10/0568; H01M 10/0567; H01M 10/0569; H01M 10/0585; H01M 10/42

(52) U.S. Cl. CPC H01M 10/0568; H01M 10/0567; H01M 10/0569; H01M 10/0585; H01M 10/4235; H01M 2300/0028

(57) ABSTRACT

Methods and systems are provided for manufacturing and implementing liquid electrolytes for aluminum-based rechargeable batteries and other secondary batteries. The liquid electrolytes may be formed from electrolyte compositions that are selected for lower corrosiveness in certain environments. In some examples, an electrolyte composition may include a salt at least partially dissolved in a solvent, the salt including Al(TFSI)₃, Al(FSI)₃, or AlI₃. In certain examples, the electrolyte composition is free of chlorine. In additional or alternative examples, the electrolyte composition may further include one or more additives, such as a halide or crown. In some examples, the salt may be formed via a neutralization reaction of a Lewis acid and a Lewis base.

### CROSS-REFERENCE TO RELATED APPLICATION

The present application claims priority to U.S. Provisional Application No. 63/604,072, entitled “NON-CORROSIVE LIQUID ELECTROLYTE FOR RECHARGEABLE MULTIVALENT BATTERIES AND METHODS OF MAKING THE SAME” and filed on Nov. 29, 2023. The entire contents of the above-identified application are hereby incorporated by reference for all purposes.

### FIELD

Embodiments of the subject matter disclosed herein relate to electrolytes for secondary batteries, such as secondary batteries including a multivalent metal electrode, and more particularly to liquid electrolytes for use in such secondary batteries and methods for making the liquid electrolytes.

### BACKGROUND

The current market for rechargeable, or secondary, batteries is dominated by lithium-ion batteries (LIBs). LIBs have been developed for several decades to achieve acceptable energy densities, cycle life, and rate performance, driven by factors such as decarbonization. However, the uneven distribution of raw materials used to manufacture LIBs, such as cobalt, has increased concerns of supply chain reliability. Rechargeable batteries that rely on alternative materials, such as other alkali-ion batteries, e.g., sodium-ion batteries (SIBs) and potassium-ion batteries (PIBs), as well as multivalent batteries (MIBs) (that is, secondary batteries that rely upon multivalent metal ions), such as magnesium batteries, zinc batteries, and aluminum batteries (AIBs), have been developed to provide other options. For SIBs and PIBs, the relatively high reactivity of sodium and potassium can present challenges to battery stability in various examples. For MIBs, one issue in some examples can be the relatively high cost and corrosivity of liquid electrolytes used for ion transfer. The corrosion of the cell case caused by such liquid electrolytes in various examples can result in more expensive and/or lower performance endeavors, such as the use of specially designed high corrosion-resistant cell cases, a man-made (e.g., artificially imposed) voltage limit and cycle life limit, and an extra protection module added to the battery pack.

### BRIEF DESCRIPTION OF THE DRAWINGS

FIG. 1 shows an example process for making a salt of an electrolyte, in accordance with at least one embodiment;

FIG. 2 shows an example process for making a solvent of an electrolyte, in accordance with at least one embodiment;

FIG. 3 shows an example process for preparing an electrolyte, in accordance with at least one embodiment;

FIG. 4 shows an example exploded view of components of a coin cell and their stacking order, in accordance with at least one embodiment;

FIG. 5 shows cyclic voltammograms of example cells including electrolytes formed from any one of various concentrations of aluminum bis(trifluoromethanesulfonyl)imide [Al(TFSI)₃] in dimethoxyethane (DME), in accordance with at least one embodiment;

FIG. 6 shows cyclic voltammograms of example cells including electrolytes formed from 0.3 M Al(TFSI)₃ in any one of various linear ether-based solvents, in accordance with at least one embodiment;

FIG. 7 shows cyclic voltammograms of example cells including electrolytes formed from 0.3 M Al(TFSI)₃ in DME with or without crown (1-aza-12-crown 4-ether) as an additive, in accordance with at least one embodiment;

FIG. 8 shows cyclic voltammograms of example cells including electrolytes formed from 0.3 M Al(TFSI)₃ in DME with or without aluminum bromide (AlBr₃) as an additive, in accordance with at least one embodiment;

FIG. 9 shows cyclic voltammograms of example cells including electrolytes formed from 0.3 M Al(TFSI)₃ in DME with or without various 20 wt % additives, in accordance with at least one embodiment;

FIG. 10 shows cyclic voltammograms of example cells including electrolytes formed from 0.3 M Al(TFSI)₃ in DME with any one of various additives, illustrating the impact of cations on bromides in electrochemical performance, in accordance with at least one embodiment;

FIG. 11 shows cyclic voltammograms of example cells including electrolytes formed from 0.3 M Al(TFSI)₃ in DME with 20 wt % AlBr₃ as an additive, illustrating the effects of replacing Al foil with aluminum oxide (Al₂O₃) in synthesizing Al(TFSI)₃, in accordance with at least one embodiment;

FIG. 12 shows cyclic voltammograms of example cells including electrolytes formed from 0.25 M Al(TFSI)₃ in DME with or without NaCl as an additive, in accordance with at least one embodiment;

FIG. 13 shows cyclic voltammograms of example cells including electrolytes formed from 0.25 M Al(TFSI)₃ in DME with or without NaBr as an additive, in accordance with at least one embodiment;

FIG. 14 shows cyclic voltammograms of example cells including electrolytes formed from 0.3 M Al(TFSI)₃ in ethylal [(ethoxymethoxy)ethane] with or without any one of various 20 wt % additives, in accordance with at least one embodiment;

FIG. 15 shows cyclic voltammograms of example cells including electrolytes formed from 0.3 M Al(TFSI)₃ in diethylene glycol dimethyl ether (DEGDME) with any one of various 20 wt % additives, in accordance with at least one embodiment;

FIG. 16 shows cyclic voltammograms of example cells including electrolytes formed from 0.3 M Al(TFSI)₃ in diethylene glycol diethyl ether (DEGDEE) with or without AlBr₃ as an additive, in accordance with at least one embodiment;

FIG. 17 shows cyclic voltammograms of example cells including electrolytes formed from 0.3 M Al(TFSI)₃ in diethylene glycol ethyl methyl ether (DEGEME) with or without crown as an additive, in accordance with at least one embodiment;

FIG. 18 shows cyclic voltammograms of example cells including electrolytes formed from any one of various concentrations of Al(TFSI)₃ in DME or tetrahydrofuran (THF), in accordance with at least one embodiment;

FIG. 19 shows cyclic voltammograms of example cells including electrolytes formed from 0.3 M Al(TFSI)₃ in THF with or without 20 wt % AlBr₃ as an additive, in accordance with at least one embodiment;

FIG. 20 shows cyclic voltammograms of example cells including electrolytes formed from 0.3 M Al(TFSI)₃ in DME or 1:1 dioxolane and DME (DOL/DME), in accordance with at least one embodiment;

FIG. 21 shows cyclic voltammograms of example cells including electrolytes formed from 0.3 M Al(TFSI)₃ in DME or any one of various linear carbonates, in accordance with at least one embodiment;

FIG. 22 shows cyclic voltammograms of example cells including electrolytes formed from 0.5 M Al(TFSI)₃ in DME or any one of various linear carbonates, in accordance with at least one embodiment;

FIG. 23 shows cyclic voltammograms of example cells including electrolytes formed from 0.3 M Al(TFSI)₃ in dimethyl carbonate (DMC), illustrating the effects of adding a resting step prior to cycling on the electrochemical performance, in accordance with at least one embodiment;

FIG. 24 shows cyclic voltammograms of example cells including electrolytes formed from 0.3 M Al(TFSI)₃ in diethyl carbonate (DEC) with or without 20 wt % AlBr₃, in accordance with at least one embodiment;

FIG. 25 shows cyclic voltammograms of example cells including electrolytes formed from 0.3 M Al(TFSI)₃ in DMC with or without any one of various 20 wt % additives, in accordance with at least one embodiment;

FIG. 26 shows cyclic voltammograms of example cells including electrolytes formed from 0.5 M Al(TFSI)₃ in DMC with or without 10 wt % aluminum iodide (AlI₃) as an additive, in accordance with at least one embodiment;

FIG. 27 shows cyclic voltammograms of example cells including electrolytes formed from 0.3 M Al(TFSI)₃ in DEC, a linear carbonate, or any one of various mixtures of fluoroethylene carbonate (FEC), a cyclic carbonate, and DEC, in accordance with at least one embodiment;

FIG. 28 shows cyclic voltammograms of example cells including electrolytes formed from 0.3 M Al(TFSI)₃ in FEC(5 vol %)/DEC with or without any one of various additives, in accordance with at least one embodiment;

FIG. 29 shows cyclic voltammograms of example cells including electrolytes formed from 0.3 M Al(TFSI)₃ in FEC(10 vol %)/DEC with or without any one of various additives, in accordance with at least one embodiment;

FIG. 30 shows cyclic voltammograms of example cells including electrolytes formed from 0.3 M Al(TFSI)₃ in ethyl acetate (EA) with or without any one of various additives, in accordance with at least one embodiment;

FIG. 31 shows cyclic voltammograms of example cells including electrolytes formed from any one of various concentrations of Al(TFSI)₃ in dimethyl sulfoxide (DMSO) with or without any one of various additives, in accordance with at least one embodiment;

FIG. 32 shows cyclic voltammograms of example cells including electrolytes formed from 0.3 M Al(TFSI)₃ in DMSO with or without any one of various additives, in accordance with at least one embodiment;

FIG. 33 shows cyclic voltammograms of example cells including electrolytes formed from 0.3 M Al(TFSI)₃ in dimethylformamide (DMF) with or without any one of various additives, in accordance with at least one embodiment;

FIG. 34 shows cyclic voltammograms of example cells including electrolytes formed from 0.3 M Al(TFSI)₃ in acetonitrile (ACN) with or without any one of various additives, in accordance with at least one embodiment;

FIG. 35 shows cyclic voltammograms of example cells including electrolytes formed from 0.3 M Al(TFSI)₃ in N-methyl-2-pyrrolidone (NMP) with or without any one of various additives, in accordance with at least one embodiment;

FIG. 36 shows cyclic voltammograms of example cells including electrolytes formed from 0.3 M Al(TFSI)₃ in pyridine with or without any one of various additives, in accordance with at least one embodiment;

FIG. 37 shows cyclic voltammograms of example cells including electrolytes formed from 0.5 M AlI₃ in DMC or formed from 0.5 M Al(TFSI)₃ in DMC with 10 wt % AlI₃ as an additive, in accordance with at least one embodiment;

FIG. 38 shows cyclic voltammograms of example cells including electrolytes formed from any one of various concentrations of AlI₃ in DMSO or formed from 0.5 M Al(TFSI)₃ in DMSO with 20 wt % AlI₃ as an additive, in accordance with at least one embodiment;

FIG. 39 shows an electrochemical impedance spectrum (EIS) of example cells including an electrolyte formed from 0.3 M Al(TFSI)₃ in DEC with 20 wt % AlBr₃ as an additive, in accordance with at least one embodiment;

FIG. 40 shows an EIS of example cells including an electrolyte formed from 0.3 M Al(TFSI)₃ in DME with 10 wt % AlBr₃ as an additive, in accordance with at least one embodiment; and

FIG. 41 shows an example separator and thickness values thereof, in accordance with at least one embodiment.

### DETAILED DESCRIPTION

Techniques described and suggested herein include at least one embodiment of an electrolyte composition, including: solvent; and a salt including Al(TFSI)3 at least partially dissolved in the solvent at a concentration of 0.3 M to 1 M, wherein the electrolyte composition may be free of chlorine ions.

In at least one embodiment, a method for forming an electrolyte composition may include: performing a surface treatment of Al foil; performing a neutralization reaction of the surface-treated Al foil with a Lewis acid at a temperature between 90° C. and 100° C. to generate a product powder; dehydrating the product powder to obtain an electrolyte salt; and dissolving the electrolyte salt in a solvent until a solution having a target concentration of the electrolyte salt is formed, wherein the target concentration of the electrolyte salt may be between 0.3 M and 1 M and wherein the solution may be free of chlorine ions.

In at least one embodiment, an aluminum-based secondary battery system may include: a cell stack, including: a stainless steel cathode; an Al foil anode; a separator interposed between the stainless steel cathode and the Al foil anode; and an electrolyte composition fluidly coupling the stainless steel cathode and the Al foil anode across the separator, the electrolyte composition including: a solvent; and an Al salt at least partially dissolved in the solvent at a concentration of 0.3 M to 1 M, wherein the electrolyte composition may be free of chlorine; and a casing enclosing the cell stack.

These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of non-corrosive liquid electrolytes for MIBs and methods to synthesize or otherwise make non-corrosive liquid electrolytes that eliminate the chlorine element. The non-corrosive liquid electrolytes illustrated in the present disclosure significantly improve corrosion resistance as well as reduce subsequent cell production cost.

MIBs of various embodiments can use corrosive liquid electrolytes for ion migration between electrodes in such electrolytes. For example, AIBs can use an ionic liquid (IL) having aluminum chloride (AlCl₃) and 1-ethyl-3-methylimidazolium chloride (EMIMCl) as a liquid electrolyte. The advantages of IL in various examples can include a wide electrochemical window of up to 2.2 V and acceptable ionic conductivity. However, ILs in some examples suffer from high material costs, low production efficiency, and strict environmental control during production. In certain examples, preparation of ILs can be an exothermic mixing process. In addition, various ILs may contain halogens, such as chlorine. Thus, the prepared ILs can be extremely hydrophilic in some examples. In certain examples, the hydrolyzed products can be corrosive vapors, such as HCl. During storage or application of ILs, in various embodiments packaging of a container and a cell can provide a water-free environment to isolate the ILs from ambient air. One or more of these drawbacks can increase the manufacturing, storage, transportation, and application costs of IL in some embodiments. For example, the highly corrosive electrolytes using ILs can easily corrode in some examples through commonly seen cell cases made of 304 stainless steel (SS), 316 SS, and Al-coated SS. Therefore, expensive materials like molybdenum, gold, and platinum can be used to coat the inner surface of the cell case to increase the corrosion resistance. However, the cost and/or availability of raw materials can prohibit the scaling-up of manufacturing cell cases using such expensive materials.

In this disclosure, a new technical approach to making non-corrosive liquid electrolytes for MIBs is demonstrated, which can be desirable in various embodiments. The disclosed non-corrosive liquid electrolytes in some embodiments can have a wide electrochemical window, a high ionic conductivity, and a good compatibility with SS even at 2 V. Although the present disclosure uses AIBs as an example to demonstrate the capabilities of some embodiments of non-corrosive liquid electrolytes and the applicability of the technical approach to make some embodiments of non-corrosive liquid electrolytes, in various examples the disclosed non-corrosive liquid electrolytes and the technical approach can also be applied to other MIBs, such as magnesium batteries and zinc batteries.

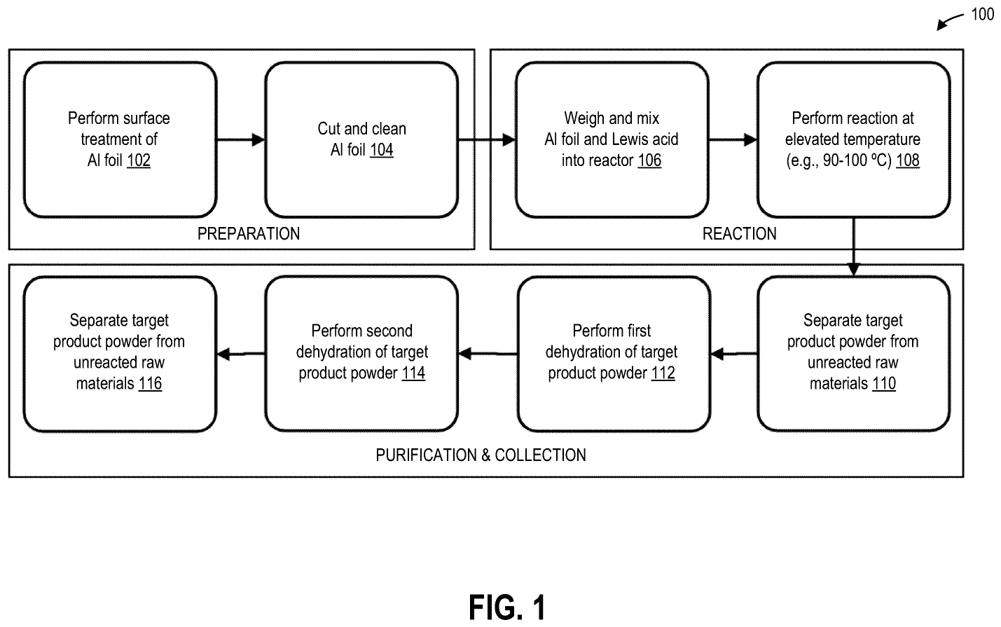

FIG. 1 depicts an example synthetic route or process 100 to make a salt of an electrolyte. During the implementation, in various embodiments the steps in FIG. 1 can be modified accordingly to make various suitable Cl-free salts for non-corrosive liquid electrolytes applicable in MIBs. For example, following the steps in FIG. 1, aluminum bis(fluorosulfonyl)imide (Al(FSI)₃) and AlI₃ can be prepared.

In at least one embodiment, the process 100 may include preparing one or more reactants at least by performing 102 surface treatment of an Al foil (or other metal foil) and cutting and cleaning 104 the treated Al foil. In certain examples, the surface treatment may include mechanical polishing and/or chemical etching. In certain examples, the surface treatment may reduce an amount of surface oxides and/or increase a surface area of the Al foil.

In at least one embodiment, the process 100 may include reacting the one or more reactants at least by weighing and mixing 106 the Al foil (e.g., as surface treated and cut and cleaned) and a Lewis acid into a reactor and performing 108 a reaction therebetween (e.g., a neutralization reaction between the Lewis acid and a Lewis base such as the Al foil, aluminum oxide powders, and/or any other aluminum species or compounds) at an elevated temperature (e.g., 90° C. to 100° C.) to generate a target product powder (e.g., the electrolyte salt).

In at least one embodiment, the process 100 may include purifying and collecting the target product powder at least by separating 110 the target product powder from at least a portion of any unreacted raw materials, performing 112 a first stage of dehydration of the target product powder, performing 114 a second stage of dehydration of the target product powder, and separating 116 the target product powder from any unreacted raw materials that may remain following dehydration. In certain examples, the dehydration may be performed immediately after salt preparation (e.g., before further steps).

In some examples, the target product powder may include a salt usable in an electrolytic composition for an Al-based secondary battery system, such as an Al salt. In certain examples, the salt may include Al(TFSI)₃, Al(FSI)₃, AlI₃, and/or any other aluminum salts that can be used in AIBs. In additional or alternative examples, analogues can be substituted in the salt, depending on a transferring ion used in a given MIB.

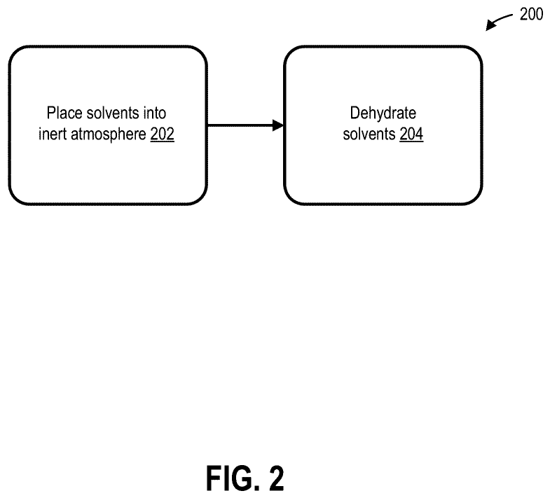

FIG. 2 depicts an example process 200 to make a solvent of an electrolyte. In at least one embodiment, the process 200 may include placing 202 one or more solvents into an inert atmosphere. In at least one embodiment, the process 200 may include dehydrating 204 the one or more solvents (e.g., placed in the inert atmosphere). In certain examples, the dehydration may be performed immediately after solvent preparation (e.g., before further steps).

Process 200 can be applied in some embodiments to prepare solvents including one or more carbonates, ethers, sulfonates, and/or any other suitable solvents that can dissolve the salts synthesized by the process 100 of FIG. 1. In some examples, the one or more solvents may include a solvent usable in an electrolytic composition for an Al-based secondary battery system. In certain examples, the solvent may include an ether, a carbonate, an acetate, an organosulfur, an amide, a nitrile, a pyrrolidone, and/or a pyridine. Representative example solvents are listed in Table 1 with corresponding physicochemical properties.

TABLE 1
Physicochemical properties of representative example solvents

| | | | | | Melting |
|---|---|---|---|---|---|
| | | | | | Point |
| | | | Dielectric | Polarity | at 1 atm |
| | | | Constant | Index | (° C.) |
| Ethers | Linear | DME | 7.3 | 5.6 | −141 |
| | | DMM | 7 to 8 | 3 to 3.5 | −105 |
| | | DEE | 4.3 | 2.8 | −116.3 |
| | | Ethylal | 2.5 | 3.1 | −66.5 |
| | | DEGDME | 7.2 | 6.8 | −64 |
| | | DEGDEE | 5.7 | 5.4 to 5.8 | −44 |
| | | DEGEME | 7.1 | 5 to 5.4 | −72 |
| | Cyclic | THF | 7.6 | 4 | −108.4 |
| | | DOL | 7.1 | 5.5 to 6 | −95 |
| Carbonates | Linear | DEC | 2.8 | 9.2 | −43 |
| | | DMC | 3.1 | 5 to 6 | 2 to 4 |
| | Cyclic | FEC | 18 | 1.38 | 18 to 23 |

| | | | | |
|---|---|---|---|---|
| Acetates | EA | 6.1 | 4.4 | −83.6 |
| Organosulfurs | DMSO | 46.7 | 7.2 | 19 |
| Amides | DMF | 38.3 | 6.4 | −61 |
| Nitriles | ACN | 37.5 | 5.8 | −45 |
| Pyrrolidones | Pyrrolidone | 32 | 8.6 | −63 |
| Pyridines | Pyridine | 12.4 | 5.3 | −41.6 |

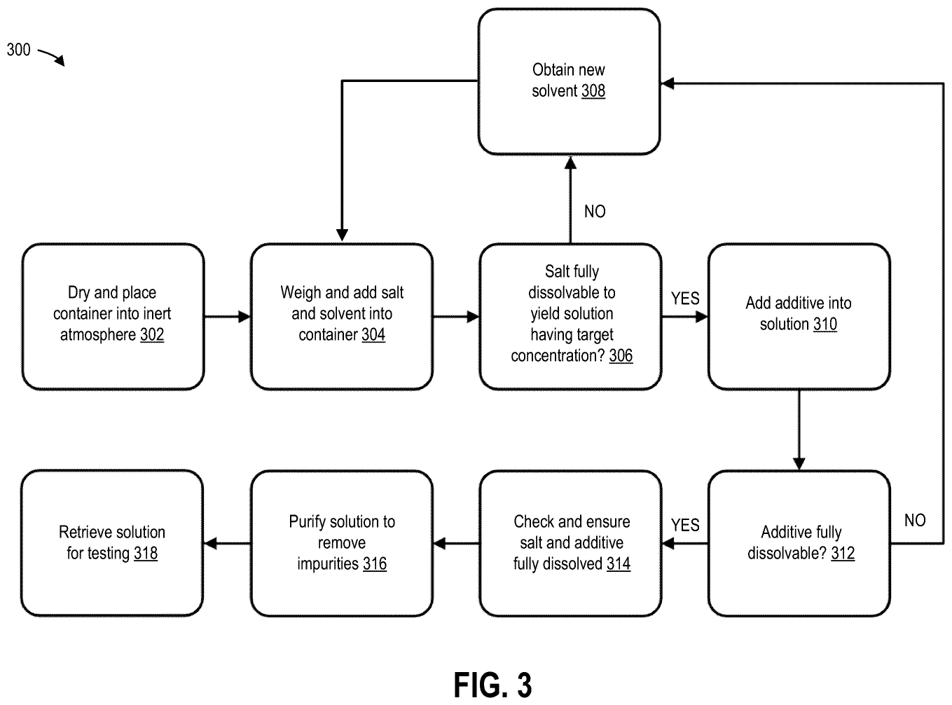

In at least one embodiment, the salt, e.g., as prepared via the process 100 of FIG. 1, may be dissolved in a solvent, e.g., as prepared via the process 200 of FIG. 2, to form an electrolyte. FIG. 3 depicts one such example process 300 to prepare an electrolyte.

In at least one embodiment, the process 300 may include drying and placing 302 a container into an inert atmosphere. In at least one embodiment, the process 300 may include weighing and adding 304 one or more salts and one or more solvents into the container.

In at least one embodiment, the process 300 may include determining or otherwise inferring 306 whether or not the one or more salts are fully dissolvable in the one or more solvents, that is, to yield a solution having a target concentration (e.g., of the one or more salts). In at least one embodiment, if it is determined or otherwise inferred 306 that the one or more salts are not fully dissolvable in the one or more solvents, the process 300 may include obtaining 308 one or more new solvents, and the one or more salts and the one or more new solvents may be weighed and added 304 into a new container (e.g., that has been dried and placed into an inert atmosphere).

In at least one embodiment, if it is determined or otherwise inferred 306 the one or more salts are fully dissolvable in the one or more solvents, the process 300 may include adding 310 one or more additives into the solution (e.g., having the target concentration). In at least one embodiment, the process 300 may include determining or otherwise inferring 312 whether or not the one or more additives are fully dissolvable (e.g., to yield a solution having a target concentration of the one or more additives). In at least one embodiment, if it is determined or otherwise inferred 312 that the one or more additives are not fully dissolvable in the one or more solvents, one or more new solvents may be obtained 308 and the one or more additives may be (re)added 310 into the solution (e.g., after the one or more salts and the one or more new solvents are weighed and added 304 into a container that has been dried and placed into an inert atmosphere).

In at least one embodiment, if it is determined or otherwise inferred 312 that the one or more additives are fully dissolvable in the one or more solvents, the process 300 may include checking and ensuring 314 that the one or more salts and the one or more additives are fully dissolved (e.g., through additional stirring, addition of heat, etc.). In at least one embodiment, the process 300 may include purifying 316 the solution (e.g., including the one or more salts and the one or more additives) to remove any impurities. In at least one embodiment, the process 300 may include retrieving 318 the solution for testing.

In some examples, the resultant solution may be an electrolytic composition usable in an Al-based secondary battery system. In certain examples, the electrolytic composition may be free of chlorine ions. In certain examples, the electrolyte composition may be non-corrosive (e.g., less than a threshold level of corrosiveness) towards certain cell case materials (e.g., stainless steel).

In some examples, a concentration of a salt in the electrolytic composition may be in a range from 0 to the concentration of a saturated solution of the salt in a solvent used to form the electrolytic composition. In certain examples, the salt concentration may be in a range from 0 to 1 M. In certain examples, the salt concentration may be in a range from 0.3 M to 1 M.

In some examples, the electrolytic composition may include one or more additives, such as an inorganic species or an organic compound. In certain examples, the one or more additives may include a halide (e.g., AlI₃ or AlBr₃). In certain examples, the one or more additives may include crown.

In some examples, a concentration of the one or more additives in the electrolytic composition may be in a range from 5 wt % to 40 wt %. In certain examples, the additive concentration may be in a range from 5 wt % to 30 wt %. In certain examples, the additive concentration may be in a range from 10 wt % to 20 wt %.

In some examples, an ionic conductivity of the electrolytic composition may be in a range of 1×10⁻⁵ S/cm-1×10⁻² S/cm. In certain examples, the ionic conductivity may be in a range of 1×10⁻³ S/cm-1×10⁻² S/cm. In certain examples, the ionic conductivity may be in a range of 2.9×10⁻³ S/cm-6.9×10⁻³ S/cm.

One factor influencing the electrolyte performance may include the solubility of salt in a solvent. Table 2 presents the highest concentration of Al(TFSI)₃ achieved in representative solvents in various experiments. In Table 2, the numbers in parentheses indicates the concentration of additive with respect to the mass of Al(TFSI)₃. For example, a unit cell coordinated to NaCl and DME displays 0.3 M (30 wt %) meaning, during the experiments, the highest concentration of Al(TFSI)₃ prepared was 0.3 M with 30 wt % NaCl (with respect to the mass of Al(TFSI)₃) as an additive in a solvent of DME. The concentrations listed in Table 2 are for illustrative purposes, and may or may not be the concentrations of saturated solutions of respective salt-additive-solvent systems and methods of various embodiments. For example, it is contemplated that the concentration of a saturated solution of Al(TFSI)₃ in DME can be above 1 M. However, in the experiments, the highest concentration of Al(TFSI)₃ in DME solution prepared was 1 M.

TABLE 2
Minimal solubility of Al(TFSI)₃ in representative solvents during experimentation

| | | Al(TFSI)₃ solubility | | | | |
|---|---|---|---|---|---|---|
| | | No | NaCl or | | | |
| | | additives | NaBr | AlBr₃ | AlI₃ | Crown |
| Linear | DME | 1M | 0.3M | 0.3M | 0.3M | 0.3M |
| ethers | | | (30 wt %) | (20 wt %) | (20 wt %) | (20 wt %) |
| | DMM | 0.3M | | 0.3M | 0.3M | |
| | | | | (20 wt %) | (10 wt %) | |
| | DEE | 0.3M | | 0.3M | <0.3M | |
| | | | | (20 wt %) | (20 wt %) | |
| | Ethylal | 0.3M | | 0.3M | 0.3M | 0.3M |
| | | | | (20 wt %) | (20 wt %) | (20 wt %) |
| | DEGDME | 0.3M | | <0.3M | <0.3M | |
| | | | | (20 wt %) | (20 wt %) | |
| | DEGDEE | 0.3M | | 0.3M | <0.3M | |
| | | | | (20 wt %) | (10 wt %) | |
| | DEGEME | 0.3M | | 0.3M | <0.3M | 0.3M |
| | | | | (20 wt %) | (20 wt %) | (20 wt %) |
| Cyclic | THF | 0.5M | | 0.3M | <0.3M | |
| ethers | | | | (20 wt %) | (10 wt %) | |
| Linear ethers + | DOL/DME | 0.3M | | 0.3M | 0.3M | |
| Cyclic ethers | | | | (20 wt %) | (20 wt %) | |
| Linear | DEC | 0.5M | | 0.3M | 0.3M | |
| carbonates | | | | (20 wt %) | (20 wt %) | |
| | DMC | 0.5M | | 0.3M | <0.5M | |
| | | | | (20 wt %) | (20 wt %) | |
| Linear | FEC(5% | 0.3M | | 0.3M | 0.3M | 0.3M |
| carbonates + | v)/DEC | | | (20 wt %) | (20 wt %) | (20 wt %) |
| cyclic | FEC(10% | 0.3M | | 0.3M | 0.3M | 0.3M |
| carbonates | v)/DEC | | | (20 wt %) | (20 wt %) | (20 wt %) |
| Acetates | EA | 0.3M | | 0.3M | <0.3M | 0.3M |
| | | | | (20 wt %) | (20 wt %) | (20 wt %) |
| Organosulfurs | DMSO | 0.5M | | 0.3M | 0.5M | 0.3M |
| | | | | (20 wt %) | (20 wt %) | (20 wt %) |
| Amides | DMF | 0.3M | | 0.3M | 0.3M | 0.3M |
| | | | | (20 wt %) | (20 wt %) | (20 wt %) |
| Nitriles | ACN | 0.3M | | 0.3M | 0.3M | 0.3M |
| | | | | (20 wt %) | (20 wt %) | (20 wt %) |
| Pyrrolidones | NMP | 0.3M | | 0.3M | 0.3M | 0.3M |
| | | | | (20 wt %) | (20 wt %) | (20 wt %) |
| Pyridines | Pyridine | 0.3M | | 0.3M | 0.3M | |
| | | | | (20 wt %) | (20 wt %) | |

The example electrolyte preparation methods shown in FIGS. 1-3 can have various desirable advantages. For example, the method of some embodiments may eliminate the usage of higher cost materials that may be used to make ILs. The synthetic reaction (e.g., to form one or more electrolyte salts) in various embodiments may be based on a neutralization process between a Lewis acid and a Lewis base (e.g., a Lewis acid can be a chemical species that contains an empty molecular orbital that is capable of accepting an electron pair from a Lewis base to form a Lewis adduct; in other words, a Lewis acid can be an electron-pair acceptor, while a Lewis base can be a substance, such as the OH⁻ ion, that can donate a pair of nonbonding electrons such that the Lewis base is an electron-pair donor).

The impurities in various embodiments can include unreacted materials and water, which may be removed by a filtration and dehydration process. An accompanied heat release during the synthetic process in various examples may be negligible compared to that undergone during the preparation processes of various ILs. The existence of water in the salt, solvent, additive, and/or electrolyte in various embodiments may: increase the impurity level in the salt, solvent, additive, and/or electrolyte; hydrolyze the salt, solvent, and/or electrolyte; and/or introduce side reactions during battery cycling in some examples. The surface treatment in the process 100 of FIG. 1 can include mechanical polishing, chemical etching, or a combination of mechanical polishing and chemical etching with an aim to remove surface oxides on the Al foil and increase surface area, which in some examples can increase the purity of the product and reaction kinetics. The reaction in some embodiments can be conducted at a temperature between 90° C. to 100° C., as described above with reference to FIG. 1 for example. It is noted that 100° C. may be the boiling point of water, dependent on a geographic location of implementing the steps of process 100.

It is noted that the salts and solvents illustrated in FIGS. 1-3 are for demonstration purposes, and are not to limit the scope of the present disclosure. There is no limitation on the scope of selections of salts and solvents, so these examples should not be construed as limiting. The salt can include one compound or a combination of multiple suitable compounds in some embodiments. The solvent can also include one compound or a combination of multiple suitable compounds in some embodiments. Advantages of the disclosed liquid electrolytes in various embodiments can include eliminating chlorine in the electrolyte, subsequently decreasing the corrosivity of the electrolyte. The liquid electrolytes can be manufactured in various embodiments using low-cost starting materials with easily accessible (e.g., low-cost, widely available, etc.) equipment to lower the manufacturing cost. Additional advantages of the disclosed electrolytes in various embodiments can include a wide electrochemical window and desirable compatibility with various materials. The disclosed technical approach can be applied to manufacturing other non-corrosive liquid electrolytes for MIBs, so the examples herein should not be construed as limiting.

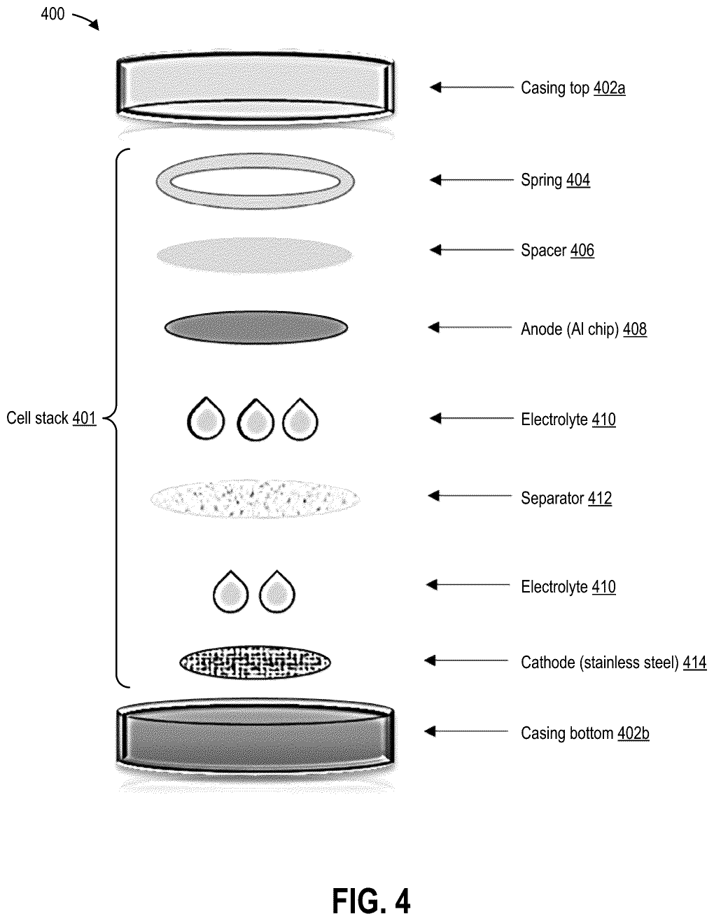

When implementing the disclosed technology, the liquid electrolytes were tested in various testing devices such as coin cells using SS as a cathode and Al foil as an anode. One such coin cell 400 is illustrated in FIG. 4. As shown, in certain embodiments, coin cell 400 may include a cell stack 401, including a spring 404, a spacer 406, an anode 408, an electrolyte 410 (e.g., the electrolyte formed by the process 300 of FIG. 3), a separator 412, additional electrolyte 410, and a cathode 414, sequentially layered within a casing 402a, 402b or other such sealed container. Accordingly, in certain examples, the electrolyte 410 may fluidly couple the anode 408 and the cathode 414 across the separator 412. In some examples, the testing devices may implement a testing protocol including a 24-hour resting step to stabilize an electrolyte and an electrode|electrolyte interface.

Example representative liquid electrolytes tested are presented in Table 3.

TABLE 3
Electrolytes tested

| Solvent | | Al(TFSI)₃ | | | Special |
|---|---|---|---|---|---|
| category | Code | concentration | Solvent | Additive | treatment |
| Linear | A11 | 1M | DME | | |
| ethers | A12 | 0.67M | | | |
| | A13 | 0.5M | | | |
| | A14 | 0.3M | | | |
| | A14_11 | 0.3M | | 30 wt % NaBr | |
| | A14_21 | 0.3M | | 10 wt % AlBr₃ | |
| | A14_22 | 0.3M | | 20 wt % AlBr₃ | |
| | A14_22o | 0.3M | | 20 wt % AlBr₃ | Use Al₂O₃ to |
| | | | | | synthesize |
| | | | | | Al(TFSI)₃ |
| | A14_31 | 0.3M | | 20 wt % AlI₃ | |
| | A14_41 | 0.3M | | 5 wt % crown | |
| | A14_42 | 0.3M | | 10 wt % crown | |
| | A14_43 | 0.3M | | 15 wt % crown | |
| | A14_44 | 0.3M | | 20 wt % crown | |
| | A15 | 0.25M | | | |
| | A15_11 | 0.25M | | 5 wt % NaCl | |
| | A15_12 | 0.25M | | 10 wt % NaCl | |
| | A15_21 | 0.25M | | 30 wt % NaBr | |
| | A21 | 0.3M | Dimethoxy | | |
| | | | methane | | |
| | | | (DMM) | | |
| | A31 | 0.3M | Diethyl | | |
| | | | ether | | |
| | | | (DEE) | | |
| | A41 | 0.3M | Ethylal | | |
| | A41_11 | 0.3M | | 20 wt % AlBr₃ | |
| | A41_21 | 0.3M | | 20 wt % crown | |
| | A51 | 0.3M | DEGDME | | |
| | A51_11 | 0.3M | | 20 wt % AlBr₃ | |
| | A51_21o | 0.3M | | 20 wt % AlI₃ | Use Al₂O₃ to |
| | | | | | synthesize |
| | | | | | Al(TFSI)₃ |
| | A61 | 0.3M | DEGDEE | | |
| | A61_11 | 0.3M | | 20 wt % AlBr₃ | |
| | A71 | 0.3M | DEGEME | | |
| | A71_11 | 0.3M | | 20 wt % crown | |
| Cyclic | B11 | 0.5M | THF | | |
| ethers | B21 | 0.3M | | | |
| | B21_11 | 0.3M | | 20 wt % AlBr₃ | |
| Linear | C11 | 0.3M | DOL/DME | | |
| ethers + | C11_11 | 0.3M | (1:1 v/v) | 20 wt % AlBr₃ | |
| cyclic ethers | | | | | |
| Linear | D11 | 0.5M | DEC | | |
| carbonates | D12 | 0.3M | | | |
| | D12_11 | 0.3M | | 20 wt % AlBr₃ | |
| | D21 | 0.3M | DMC | | |
| | D21r | 0.3M | | | Rest for 24 h |
| | | | | | prior to cycling |
| | D21_11 | 0.3M | | 20 wt % AlBr₃ | |
| | D21_22or | 0.3M | | 20 wt % AlI₃ | Use Al₂O₃ to |
| | | | | | synthesize |
| | | | | | Al(TFSI)₃; rest |
| | | | | | for 24 h prior to |
| | | | | | cycling |
| | D22r | 0.5M | | | Rest for 24 h |
| | | | | | prior to cycling |
| | D22_11r | 0.5M | | 10 wt % AlI₃ | Rest for 24 h |
| | | | | | prior to cycling |
| Linear | E11 | 0.3M | FEC(5 | | |
| carbonates + | E11_11 | 0.3M | vol %)/DEC | 20 wt % AlBr₃ | |
| cyclic | E11_21 | 0.3M | | 20 wt % crown | |
| carbonates | E21 | 0.3M | FEC(10 | | |
| | E21_11 | 0.3M | vol %)/DEC | 20 wt % AlBr₃ | |
| | E21_21 | 0.3M | | 20 wt % crown | |
| Acetates | F11 | 0.3M | EA | | |
| | F11_11 | 0.3M | | 20 wt % AlBr₃ | |
| | F11_21 | 0.3M | | 20 wt % crown | |
| Organosulfurs | G11r | 0.3M | DMSO | | Rest for 24 h |
| | | | | | prior to cycling |
| | G11_11 | 0.3M | | 20 wt % AlBr₃ | |
| | G11_21 | 0.3M | | 20 wt % crown | |
| | G11_31r | 0.3M | | 20 wt % AlI₃ | Rest for 24 h |
| | G21r | 0.5M | | | prior to cycling |
| | G21_11r | 0.5M | | 20 wt % AlI₃ | |
| Amides | H11 | 0.3M | DMF | | |
| | H11_11o | 0.3M | | 20 wt % AlBr₃ | Use Al₂O₃ to |
| | H11_21o | 0.3M | | 20 wt % crown | synthesize |
| | | | | | Al(TFSI)₃ |
| Nitriles | I12 | 0.3M | ACN | | |
| | I12_11 | 0.3M | | 20 wt % AlBr₃ | |
| | I12_21 | 0.3M | | 20 wt % crown | |
| | I12_31o | 0.3M | | 20 wt % AlI₃ | Use Al₂O₃ to synthesize |
| | | | | | Al(TFSI)₃ |
| Pyrrolidones | J11 | 0.3M | NMP | | |
| | J11_11 | 0.3M | | 20 wt % AlBr₃ | |
| | J11_21 | 0.3M | | 20 wt % crown | |
| Pyridine | K11r | 0.3M | Pyridine | | Rest for 24 h prior to |
| | | | | | cycling |
| | K11_11 | 0.3M | | 20 wt % AlBr₃ | |
| | K11_21or | 0.3M | | 20 wt % AlI₃ | Use Al₂O₃ to synthesize |
| | | | | | Al(TFSI)₃; rest for 24 h |
| | | | | | prior to cycling |

The present disclosure will describe the implementation of example embodiments of the disclosed technology based on each representative category of solvents.

### Ethers

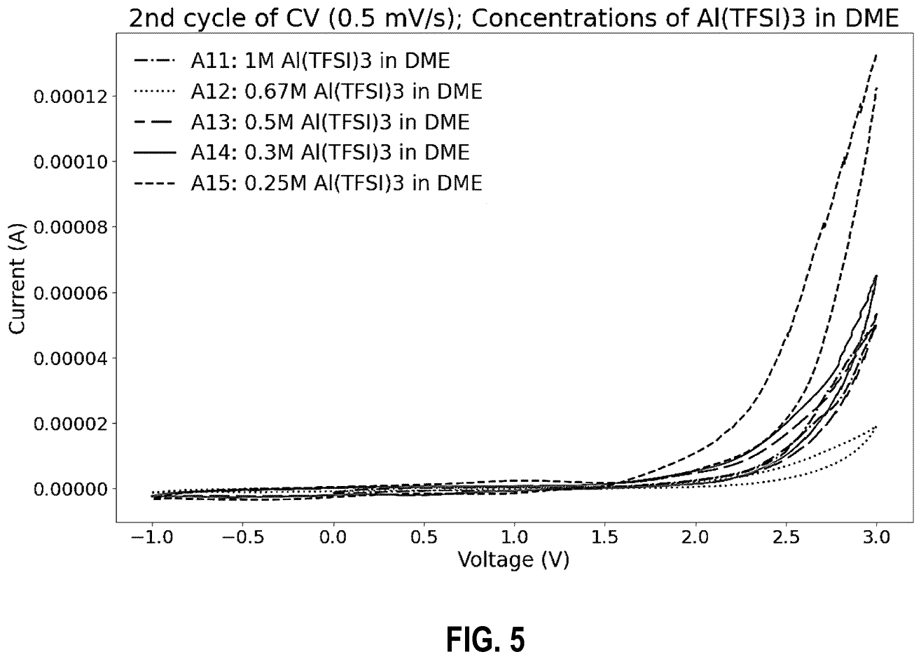

Ethers can be used for liquid electrolytes in rechargeable batteries. When implementing such ethers as solvents for liquid electrolytes in MIBs, the preparation process can follow the procedures described in FIGS. 1-3. AIBs are exemplarily presented to demonstrate the performance of ether-based liquid electrolytes in MIBs of some embodiments. FIG. 5 presents electrolytes with various example concentrations of Al(TFSI)₃ in DME. Here, DME is an example representative of a linear ether. There were no prominent peaks during the anodic scan in the various example electrolytes tested. However, when the voltage is above 1.5 V, the sharp increase in current indicates that in some examples electrolyte oxidation, SS corrosion, or both electrolyte oxidation and SS corrosion can become evident. Although 1 M is the highest concentration achieved in DME-based electrolytes during various experiments, the applicable Al(TFSI)₃ concentration in DME in some embodiments can be in a range from 0 to the concentration of the saturated solution of Al(TFSI)₃ in DME or other ethers. In additional or alternative examples, the Al(TFSI)₃ concentration in DME can be in a range from 0 to 1 M. Based on the current increase during the anodic scan, a desirable concentration of Al(TFSI)₃ in DME in some embodiments can be in a range from 0.3 to 1 M.

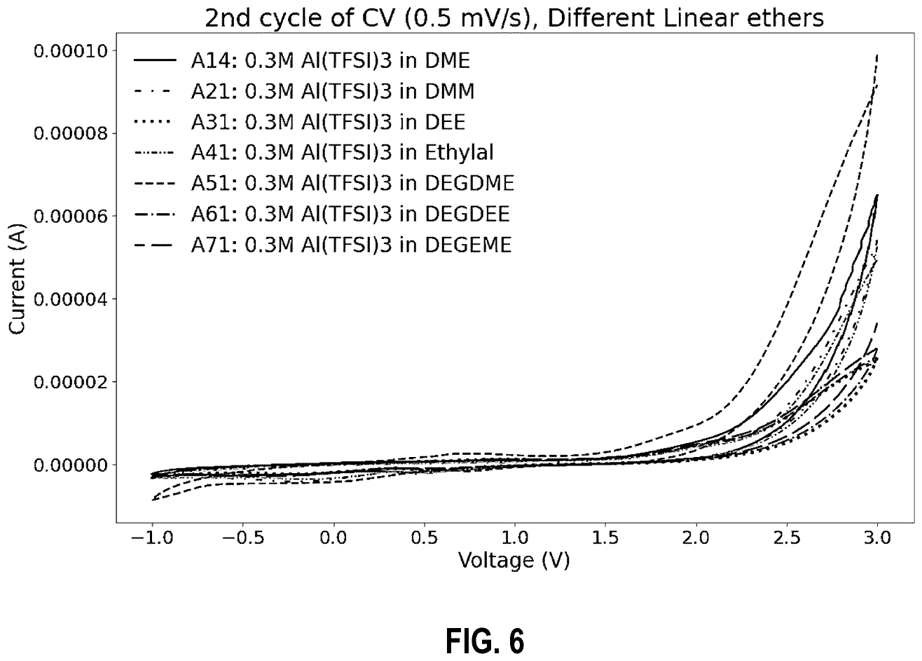

In some embodiments, 0.3 M Al(TFSI)₃ in various ether-based solvents can be used as liquid electrolytes. As shown in FIG. 6, 0.3 M Al(TFSI)₃ in DEGDME (A51) can display a wave at a voltage of <−0.5 V during the cathodic scan, representing aluminum plating. The other ether-based electrolytes shown in FIG. 6 do not display prominent aluminum plating or stripping signals, while the stability of electrolytes and electrolyte|SS interface can stand a voltage up to 2 V. Thus, according to the example of FIG. 6, linear ethers can be solvents for liquid electrolytes for some embodiments of MIBs.

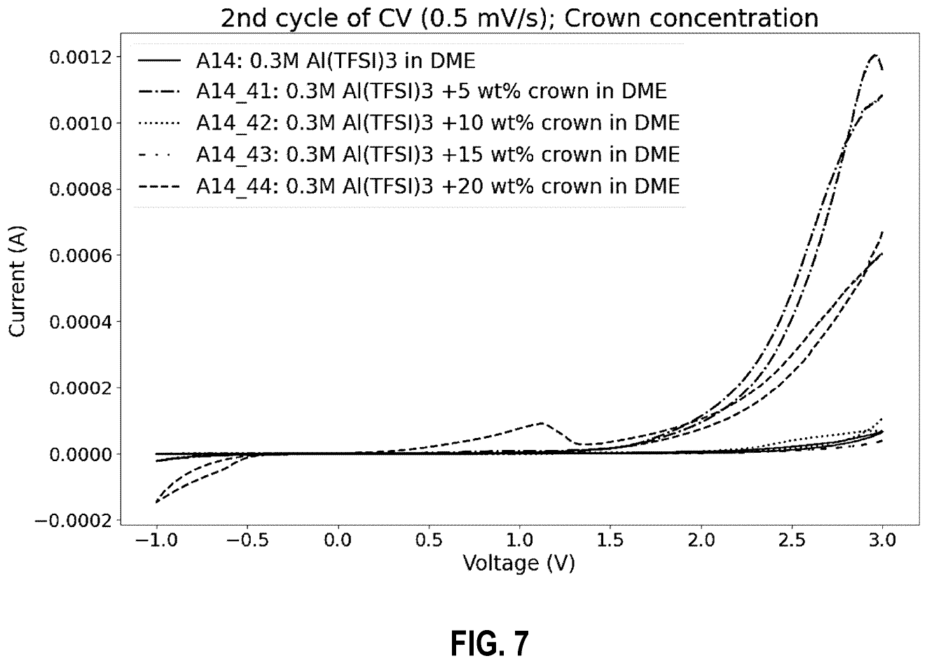

In some embodiments, one or more additives can be added into ether-based electrolytes, referring to the example experiment of FIG. 7. For example, crown was added into 0.3 M Al(TFSI)₃ in DME to form the liquid electrolytes. As shown in FIG. 7, 0.3 M Al(TFSI)₃ and 20 wt % crown in DME (A14_44) displays a wave at a voltage of <−0.5 V during the cathodic scan, representing aluminum plating, and a peak at ˜1.1 V during the anodic scan, representing aluminum stripping. However, electrolyte oxidation, SS corrosion, or both electrolyte oxidation and SS corrosion are prominent in this example when the voltage is >1.5 V. For 0.3 M Al(TFSI)₃ and 5 wt % crown in DME (A14_41), a relatively small signal at ˜−1 V during the cathodic scan indicates the aluminum plating is not a dominant process in this example. While A14_41 does not display signals indicating aluminum stripping during the anodic scan in this example, phenomena including electrolyte oxidation, SS corrosion, or both electrolyte oxidation and SS corrosion are more prominent in this example compared to A14_44 when the voltage is >1.5 V. The other ether-based electrolytes shown in the example of FIG. 7 do not display prominent aluminum plating and stripping signals, while the electrolytes and SS can stand a voltage up to 2 V or even 2.5 V.

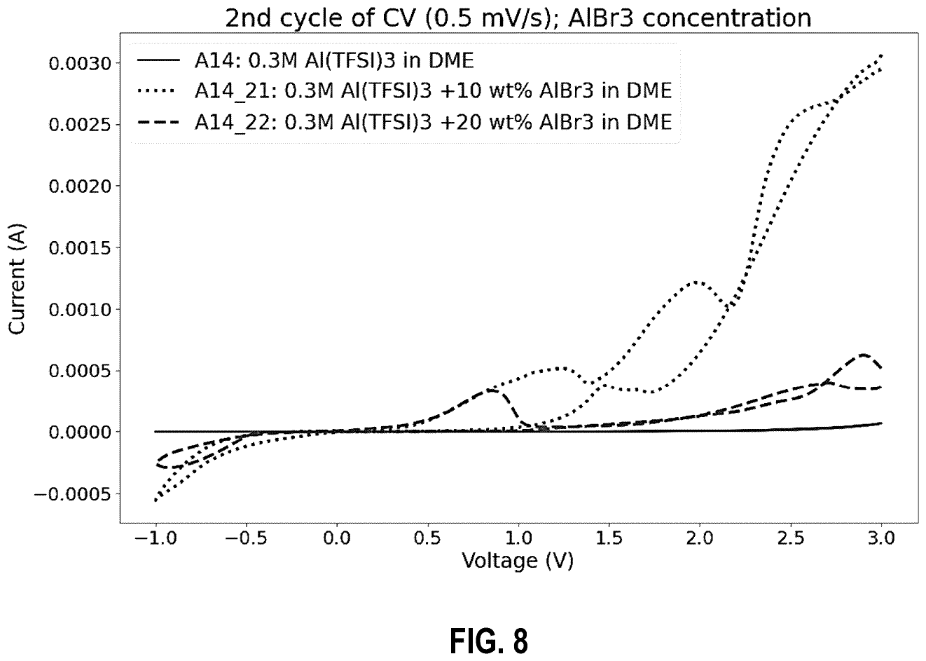

As shown in the example experiment of FIG. 8, AlBr₃ was also used as an additive in electrolytes of 0.3 M Al(TFSI)₃ in DME. A14_22, 0.3 M Al(TFSI)₃ and 20 wt % AlBr₃ in DME, displays a wave at a voltage range from −1 V to −0.5 V during the cathodic scan, representing aluminum plating, and a peak at a voltage of ˜0.8 V, representing aluminum stripping. When the AlBr₃ was present at 10 wt %, A14_21, there are evident symmetrical peaks at −1 V and 1 V in this example, representing aluminum plating and stripping, respectively. However, electrolyte oxidation, SS corrosion, or both electrolyte oxidation and SS corrosion are more prominent in A14_21 compared to A14 in this example and A14_22 when the voltage is >1.5 V. According to the example experiments of FIGS. 7 and 8, additive concentration in an ether-based electrolyte in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %.

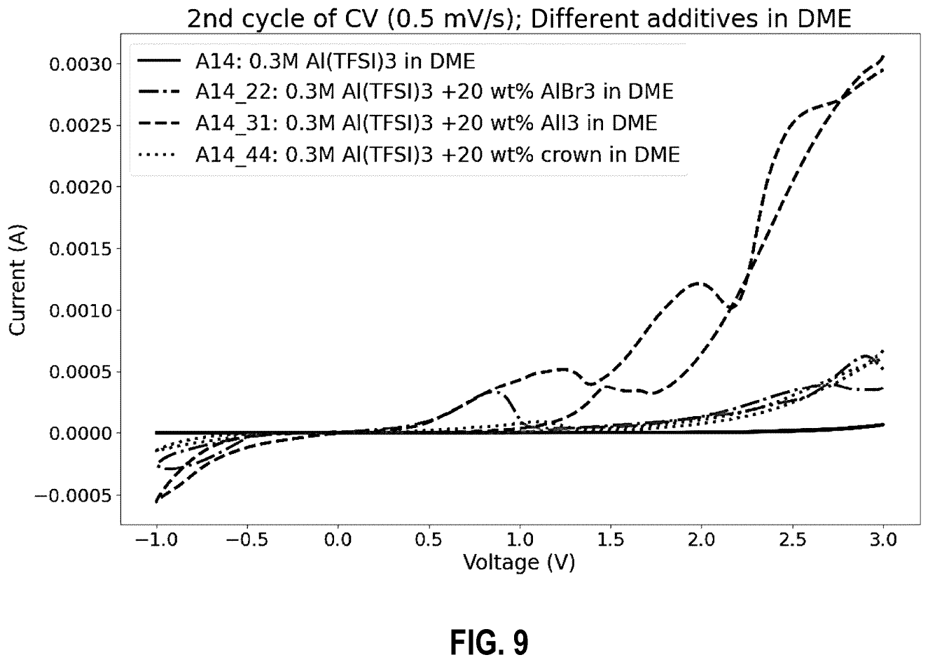

FIG. 9 depicts an example experiment adding 20 wt % various additives into electrolytes of 0.3 M Al(TFSI)₃ in DME. With additives, aluminum plating and stripping can be observed in this example in a voltage range from −1 V to −0.5 V and a range of 0.5 V to 1.5 V, respectively. The A14_22 (having AlBr₃) and A14_22|SS interface in this example show an excellent stability even up to 2 V. The A14_31 (having AlI₃) and A14_31|SS interface displayed most evident peaks indicating electrolyte oxidation, SS corrosion, or both electrolyte oxidation and SS corrosion when voltage>1.5 V.

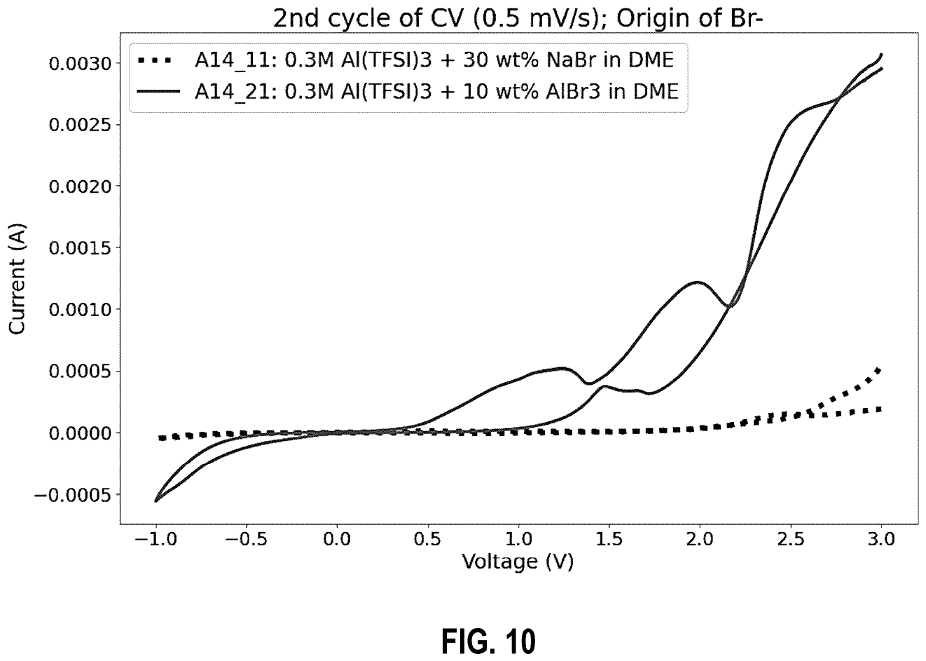

To explore the origin of the enhanced performance of 0.3 M Al(TFSI)₃ and 20 wt % AlBr₃ in DME, AlBr₃ was replaced with NaBr while keeping the concentration of Br⁻, as shown in FIG. 10. Based on the negligible aluminum plating and stripping signals in 0.3 M Al(TFSI)₃+10 wt % NaBr in DME (A14_11), in this example the increased presence of aluminum or aluminum compounds or aluminum species in the electrolyte can be beneficial for aluminum plating and stripping in various embodiments.

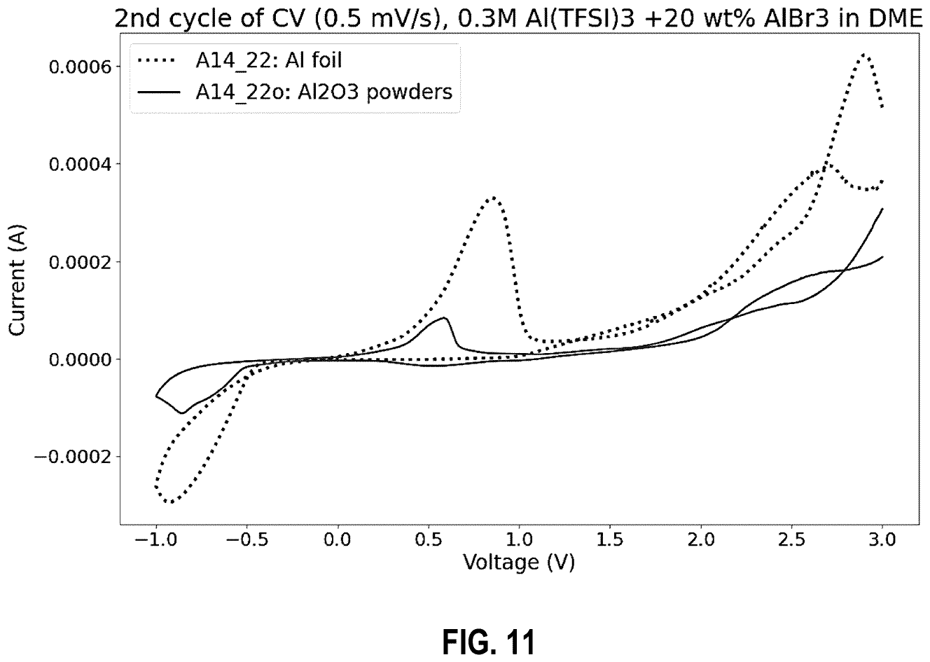

In some experiments, Al₂O₃ was investigated to explore the feasibility of replacing Al foil in the method of FIG. 1 to further lower the production cost. As shown in the example experiment of FIG. 11, using Al foil or Al₂O₃ to synthesize Al(TFSI)₃ resulted in a similar cyclic voltammetry curve shape. However, using Al foil leads to more prominent cathodic and anodic peaks compared to the Al₂O₃. In addition, using Al₂O₃ to synthesize Al(TFSI)₃ seems to result in more impurities represented by more cathodic peaks below −0.5 V and more anodic peaks above 2 V. In some embodiments, Al foil and Al₂O₃ are each applicable to synthesize Al(TFSI)₃.

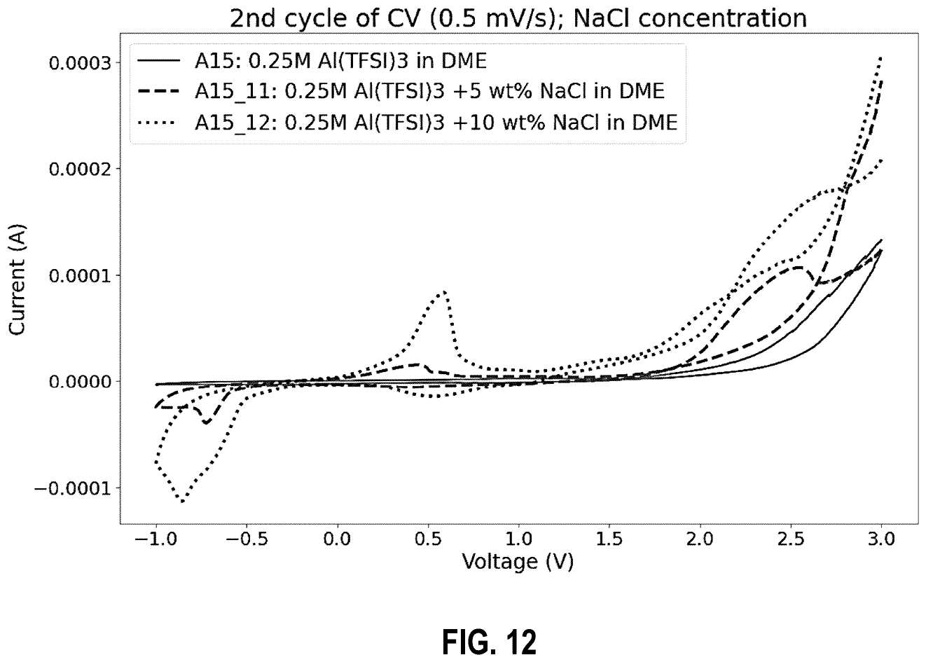

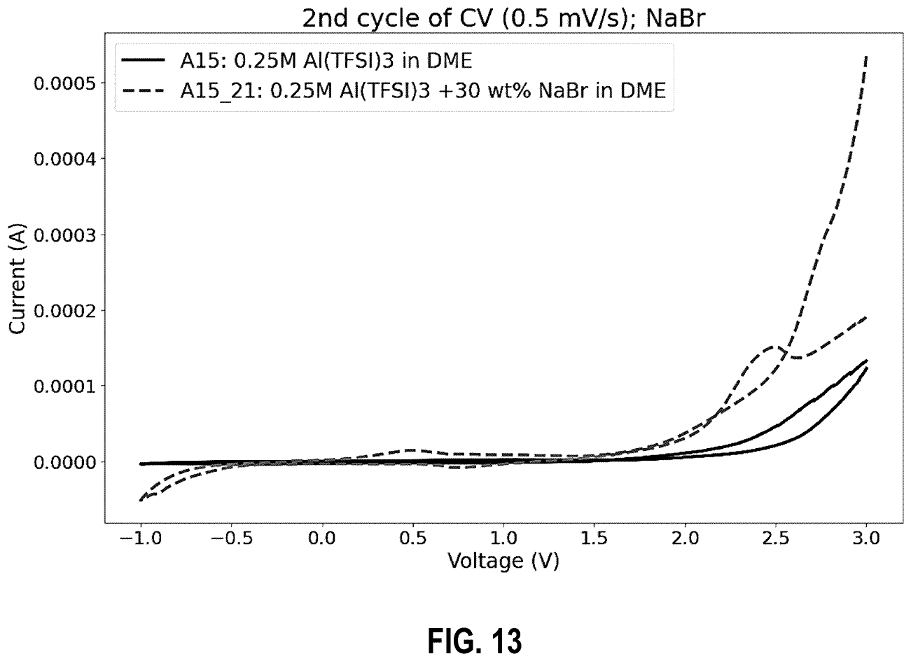

In some embodiments, the existence of aluminum cation in the additives is demonstrated to be desirable. To better understand the function of anions in the additives, halides were added as additives in example experiments. As shown in the example experiments of FIGS. 12 and 13, halogens in the additives can improve the performance of electrolytes. Aluminum plating and stripping are present when the voltage is below −0.5 V and ˜0.5 V, respectively. In this example, the electrochemical window is pushed to above 2 V with halide additives (FIGS. 12 and 13).

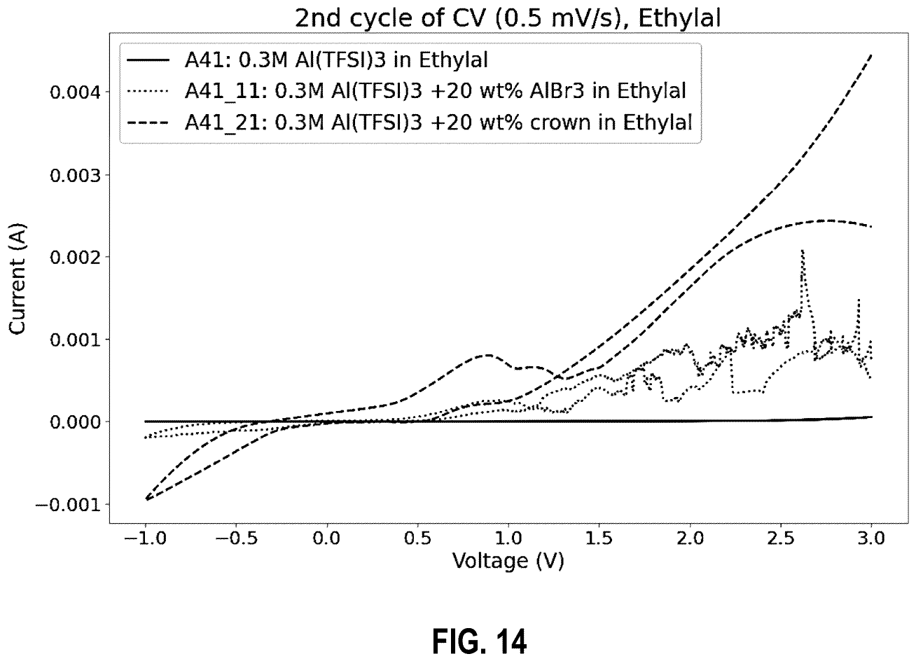

In some embodiments, ethylal can be used as a linear ether solvent to make electrolytes of 0.3 M Al(TFSI)₃ in ethylal with different additives, as shown in the example experiment of FIG. 14. Adding additives (A41_11 and A41_21) can enhance aluminum plating and stripping, demonstrated by the reduction waves in a voltage range from −1 V to −0.5 V and oxidation peaks in a voltage range from 0.5 V to 1 V, respectively. However, the rapid current rise at high voltage (>1.2 V) is highly possibly caused by electrolyte oxidation, SS corrosion, or both electrolyte oxidation and SS corrosion, especially for the 20 wt % AlBr₃ electrolyte (A41_11). In addition, Al(TFSI)₃ may have relatively low solubility in ethylal. The noisy curves may also be attributed to disturbance by the undissolved salts or relatively high reactivity of ethylal. Moreover, even though A41, A41_11, and A41_21 are labeled as 0.3 M Al(TFSI)₃ in ethylal, they may be Al(TFSI)₃ saturated solutions and the actual concentrations of the solutions may be lower than 0.3 M in some embodiments.

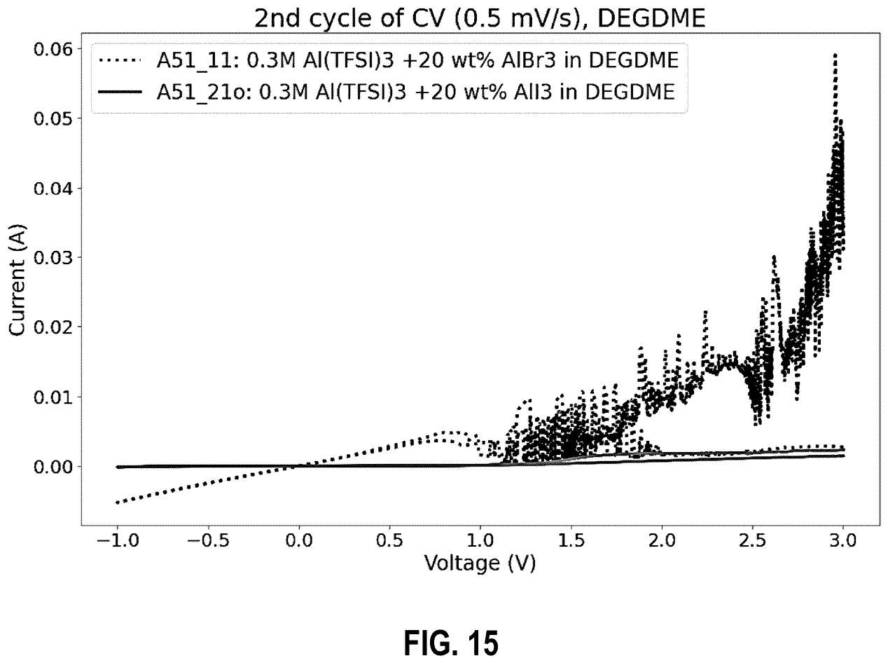

When another linear ether, DEGDME, was used as the electrolyte solvent, adding AlBr₃ as an additive (A51_11) also shows significant electrolyte oxidation, SS corrosion, or both electrolyte oxidation and SS corrosion when voltage is >1.0 V (A51_11 in the example experiment of FIG. 15). When AlI₃ was used as an additive (A51_21o), the electrolyte and electrolyte|SS interface show better stability at high voltage. Moreover, Al(TFSI)₃ may have relatively low solubility in DEGDME, and the noisy curves in A51_11 may be also attributed to disturbance by the undissolved salts or relatively high reactivity of DEGDME. Even though A51_11 and A51_21o are labeled as 0.3 M Al(TFSI)₃ in DEGDME, they may be Al(TFSI)₃ saturated solutions and the actual concentrations of the solutions may be lower than 0.3 M in some embodiments.

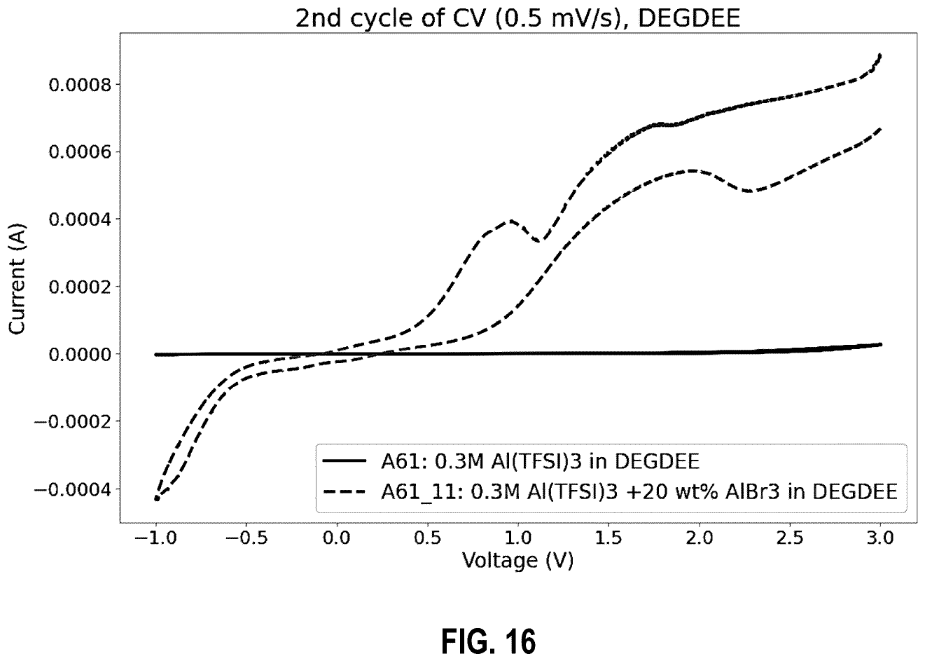

As shown in the example experiment of FIG. 16, when DEGDEE was used as the electrolyte solvent, adding 20 wt % AlBr₃ into 0.3 M Al(TFSI)₃ in DEGDEE (A61_11) facilitates aluminum plating, represented by the wave during the cathodic scan when voltage is <−0.5 V, and aluminum stripping, represented by the peak during the anodic scan at a voltage of ˜1 V. However, electrolyte oxidation, SS corrosion, or both electrolyte oxidation and SS corrosion are more significant in electrolytes with additive(s), compared to electrolytes with no additives. Thus, A61_11 has a narrower electrochemical window of 1.1 V.

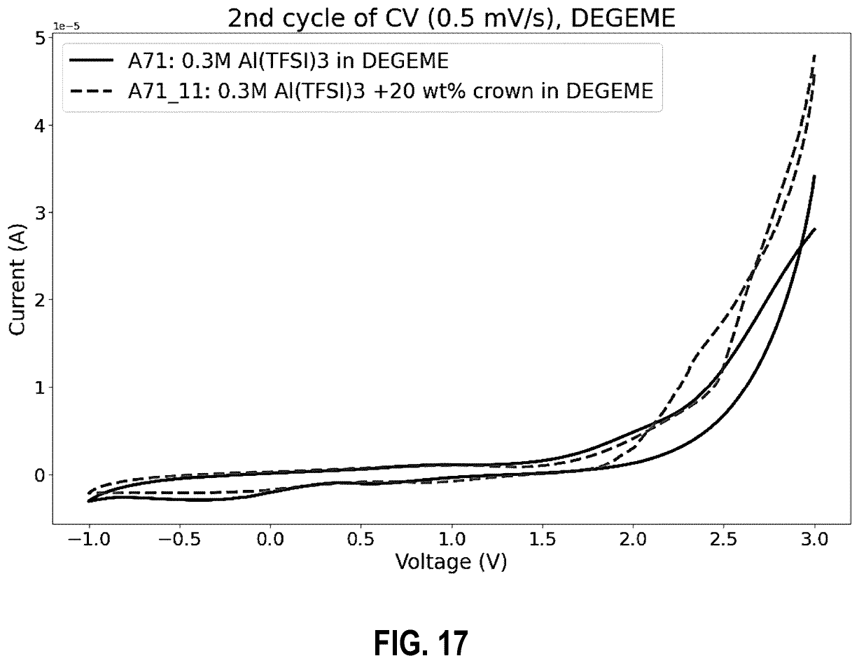

As shown in the example experiment of FIG. 17, when DEGEME was used as the electrolyte solvent, adding 20 wt % crown into 0.3 M Al(TFSI)₃ in DEGEME, A71_11, does not significantly influence aluminum plating, represented by the wave during the cathodic scan at a voltage of ˜−0.5 V, or aluminum stripping, represented by the peak during the anodic scan at a voltage of ˜1.0 V. However, electrolyte oxidation, SS corrosion, or both electrolyte oxidation and SS corrosion are more significant in electrolytes with additive(s), compared to electrolytes with no additives. Therefore, A71_11 has a narrower electrochemical window of 1.5 V. It should be noted that Al(TFSI)₃ may have relatively low solubility in DEGEME, and the waves at a voltage of >1.5 V may also be attributed to the disturbance by the undissolved salts or relatively high reactivity of DEGEME. Moreover, even though A71 and A71_11 are labeled as 0.3 M Al(TFSI)₃ in DEGEME, they may be Al(TFSI)₃ saturated solutions and the actual concentrations of the solutions may be lower than 0.3 M in some embodiments.

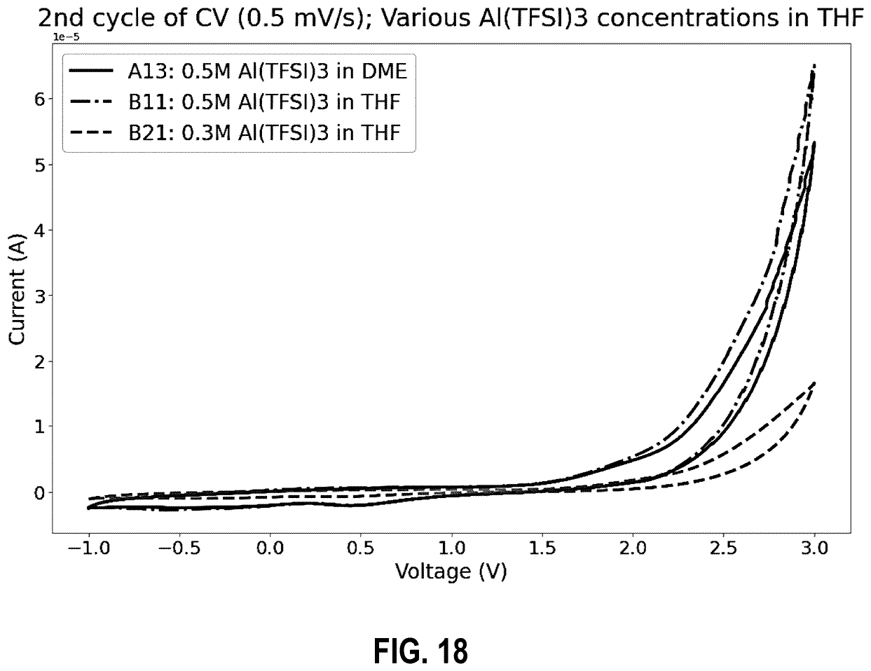

For cyclic ethers, THF can be used as an example representative electrolyte solvent. As shown in the example experiment of FIG. 18, replacing DME with THF does not significantly change the electrochemical reactions during charge/discharge. During the cathodic scan, an electrolyte of 0.5 M Al(TFSI)₃ in DME (A13) and an electrolyte of 0.5 M Al(TFSI)₃ in THF (B11) delivered identical curves with a relatively small wave indicating aluminum plating. However, the THF-based electrolyte (B11) displays higher current than the DME-based electrolyte (A13), especially when the voltage is higher than 2 V. When decreasing the Al(TFSI)₃ concentration from 0.5 M to 0.3 M in THF, weaker signals were observed in both the cathodic and anodic scans.

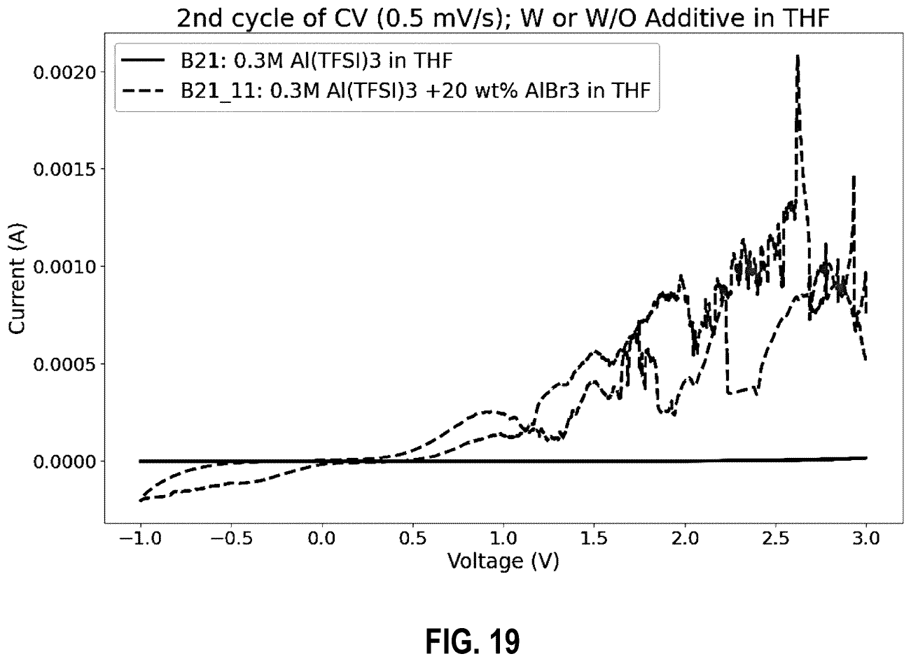

Referring to the example experiment of FIG. 19, when adding 20 wt % AlBr₃ into the electrolyte of 0.3 M Al(TFSI)₃ in THF, aluminum plating was promoted (B21_11, voltage of ˜−0.5 V), and aluminum stripping was also signified (voltage of ˜1 V). However, adding additives also intensified electrolyte oxidation, SS corrosion, or both electrolyte oxidation and SS corrosion, when the voltage is higher than 1.1 V. It should be noted that Al(TFSI)₃ may have relatively low solubility in THF in some embodiments. The noisy curves in B21_11 may also be attributed to the disturbance by the undissolved salts or relatively high reactivity of THF. Moreover, even though B21_11 is labeled as 0.3 M Al(TFSI)₃ in THF, it may be Al(TFSI)₃ saturated solution and the actual concentrations of the solution may be lower than 0.3 M in some embodiments.

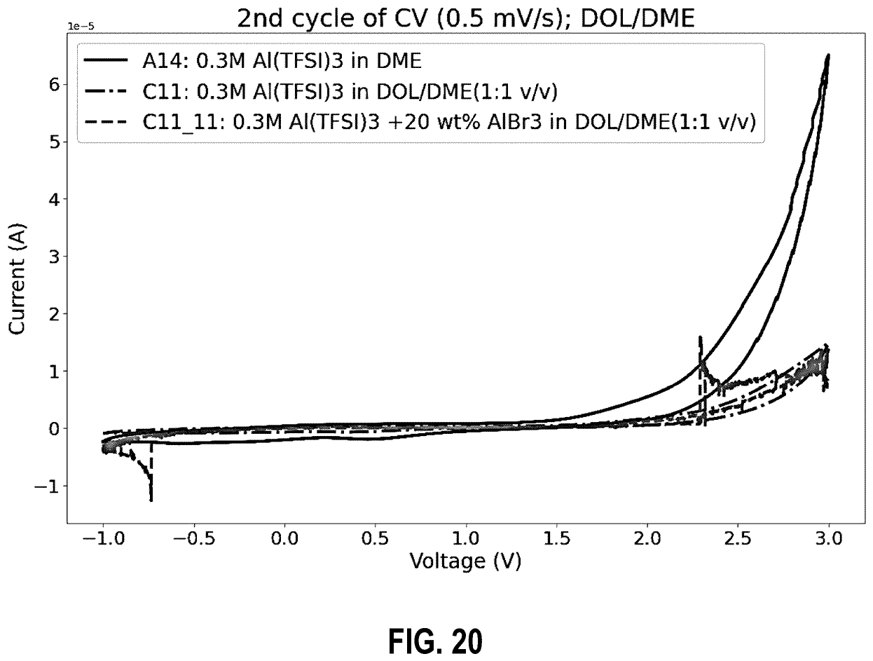

In some embodiments, a mixture including linear ethers and cyclic ethers can be used as an electrolyte solvent. As shown in the example experiment of FIG. 20, when using a mixture of DOL and DME with a volume ratio of 1:1 as an example (C11), electrolyte oxidation, SS corrosion, or both electrolyte oxidation and SS corrosion was suppressed compared to using a linear ether solvent (A14), supported by the current increase when voltage is higher than 1.5 V in A14. However, aluminum plating and stripping in C11 were not prominent in this example. Adding 20 wt % AlBr₃ into 0.3 M Al(TFSI)₃ in DOL/DME results in a noisy signal in this example. It should be noted that Al(TFSI)₃ may have relatively low solubility in DOL/DME (1:1 v/v), and the noisy signals at a voltage of >1.5 V (C11_11) may also be attributed to the disturbance by the undissolved salts or relatively high reactivity of DOL/DME (1:1 v/v). Moreover, even though C11 and C₁₁₋₁₁ are labeled as 0.3 M Al(TFSI)₃ in DOL/DME (1:1 v/v), they may be Al(TFSI)₃ saturated solutions and the actual concentrations of the solutions may be lower than 0.3 M in some embodiments. Another possible reason that can lead to the noisy signals in some examples may be the relatively high reactivity of DOL/DME, causing an unstable electrolyte|SS interface.

Electrolytes for MIBs can include Cl-free salts and Cl-free solvents. In some embodiments, the electrolytes may further include one or more additives. During implementation in AIBs, one representative Cl-free salt can be Al(TFSI)₃. One example representative Cl-free solvent can include an ether or a combination of multiple ethers. The ether in some embodiments can be a linear ether, a cyclic ether, a mixture of a linear ether and a cyclic ether, etc. The Cl-free salt concentration in some embodiments can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ may have lower solubility in some solvents. The concentration mentioned above, e.g., 0.3 M and 1 M, shall not be higher than the Al(TFSI)₃ concentration of a saturated solution in some embodiments. In some embodiments, the one or more additives include inorganic species, such as halides, and/or organic compounds, such as crown. Additive concentration can be in a range from 5 wt % to 40 wt % in some examples. In additional or alternative examples, the additive concentration can be in a range from 5 wt % to 30 wt %. In additional or alternative examples, the additive concentration can be in a range from 10 wt % to 20 wt %. In some embodiments, the starting materials to synthesize Al(TFSI)₃ can either be Al foil or Al₂O₃ depending on factors like production cost, purification requirements, and/or accessible equipment. Some example representative electrolytes, like 0.25 M Al(TFSI)₃+5 wt % NaCl in DME, 0.3 M Al(TFSI)₃+20 wt % AlBr₃ in DME, and 0.3 M Al(TFSI)₃+20 wt % crown in DME, can have reversible aluminum plating/stripping demonstrated by symmetrical peaks in a range of −1 V to −0.5 V and in a range of 0.5 V to 1.5 V, respectively. Electrolyte oxidation, SS corrosion, or both electrolyte oxidation and SS corrosion did not happen in some example experiments until the voltage was ˜2 V in the representative electrolytes.

### Carbonates

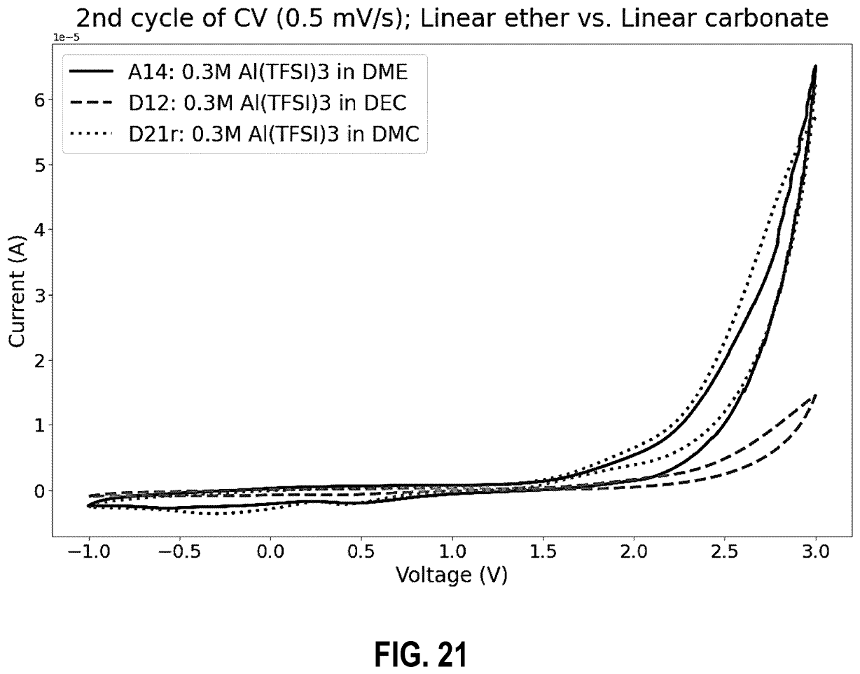

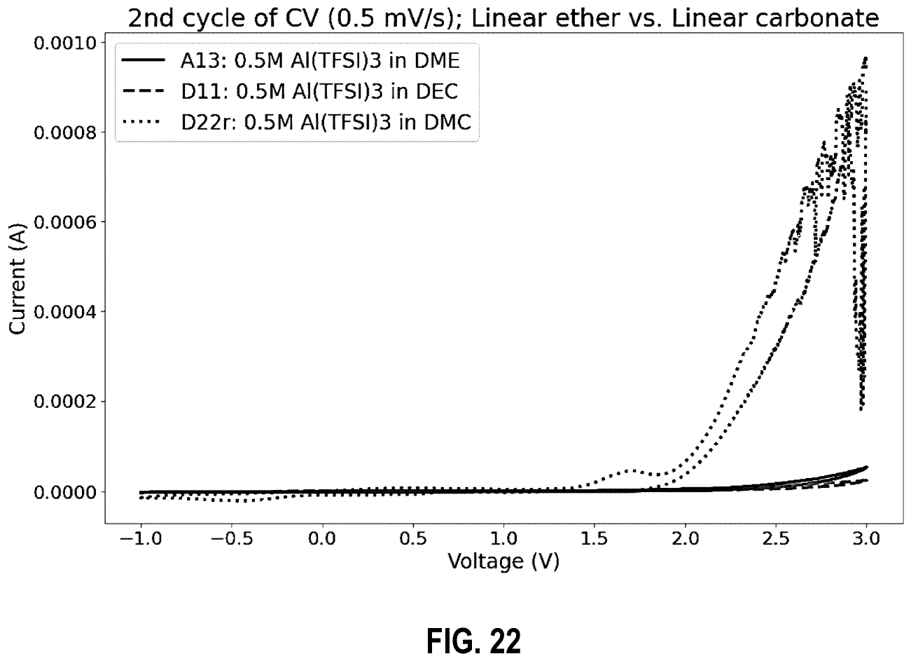

In some example experiments, carbonates were tested as electrolyte solvents for MIBs. FIGS. 21 and 22 show example experiments including representative linear carbonates as the electrolyte solvents to compare with a linear ether solvent. Referring to the example experiment of FIG. 21, a DEC-based electrolyte (D12) demonstrates a better resistance to electrolyte oxidation, SS corrosion, or both electrolyte oxidation and SS corrosion, than a DME-based electrolyte (A14) or a DMC-based electrolyte (D21r). Aluminum plating in this example is also suppressed more in D12 than A14 and D21r. Referring to the example experiment of FIG. 22, when the concentration of Al(TFSI)₃ was increased from 0.3 M to 0.5 M, the DMC-based electrolyte (D22r) displayed a more evident peak during the cathodic scan at a voltage˜−0.5 V, indicating aluminum plating, while a more evident wave during the anodic scan at a voltage of 1.7 V, indicating aluminum stripping. However, 0.5 M Al(TFSI)₃ in DMC in this example displays a noisy curve (D22r in FIG. 22). This may be attributed to disturbance by the undissolved salts, which can be caused by relatively low solubility of Al(TFSI)₃ in DMC, or relatively high reactivity of DMC. Thus, even though D22r is labeled as 0.5 M Al(TFSI)₃ in DMC, it may be a Al(TFSI)₃ saturated solution and the actual concentration of the solution may be lower than 0.5 M in some embodiments. The increase of the current in D22r may reflect electrolyte oxidation, SS corrosion, or both electrolyte oxidation and SS corrosion.

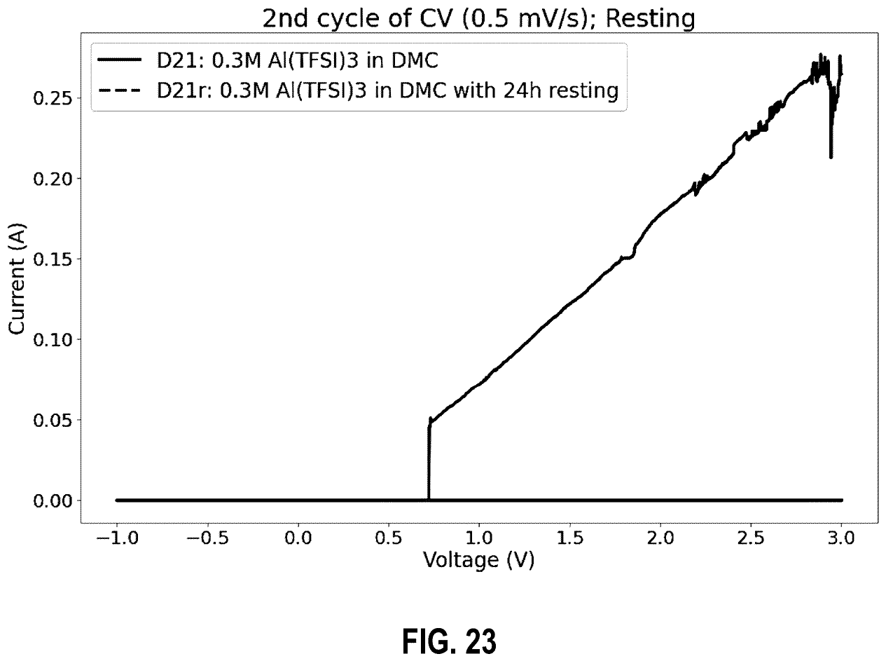

In some embodiments, when noisy signals appear, a resting step may be performed to passivate the electrode surface. As shown in the example experiment of FIG. 23, by adding a 24-hour resting step (D21r) prior to cycling, the noisy signal disappeared, while the cell without a 24-hour resting step (D21) displayed a rapid current increase when the voltage was higher than 0.7 V. Similar testing procedures can be applied for cell testing in certain embodiments as a preventive measure, even for the electrolytes that do not deliver noisy signals.

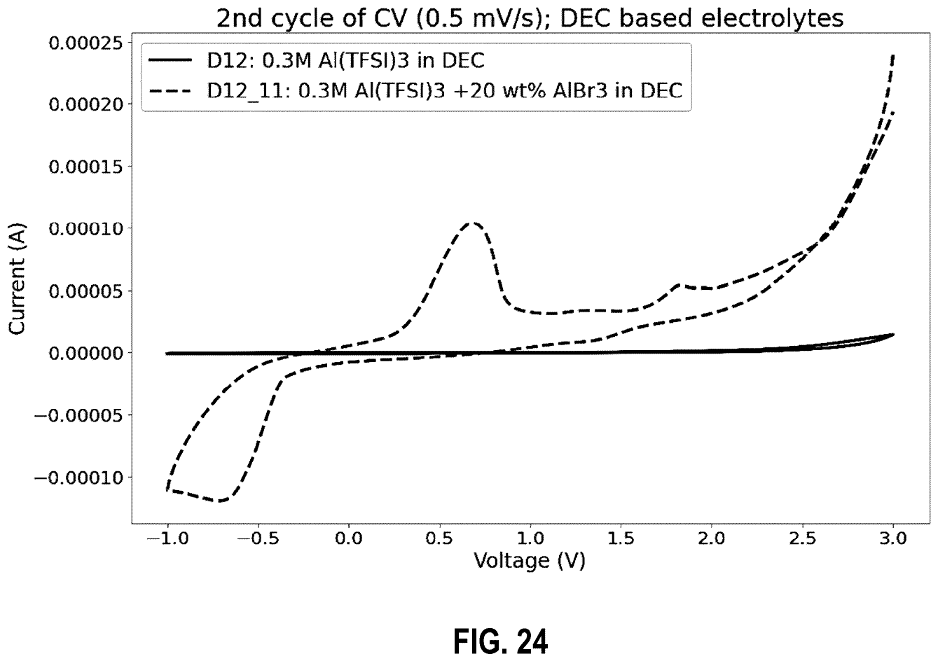

Adding additives to the linear carbonate-based electrolytes can improve aluminum plating and stripping in some embodiments. As shown in the example experiment of FIG. 24, adding 20 wt % AlBr₃ (D12_11) can promote aluminum plating, represented by a peak in a voltage range of −1 V to −0.5 V, and aluminum stripping, represented by a peak in a voltage range of 0.5 V to 1 V. However, the peaks and waves that appear in a voltage range of >1.7 V indicate electrolyte oxidation, SS corrosion, or both electrolyte oxidation and SS corrosion. 0.3 M Al(TFSI)₃+20 wt % AlBr₃ in DEC (D12_11) is still an applicable electrolyte for MIBs in various embodiments.

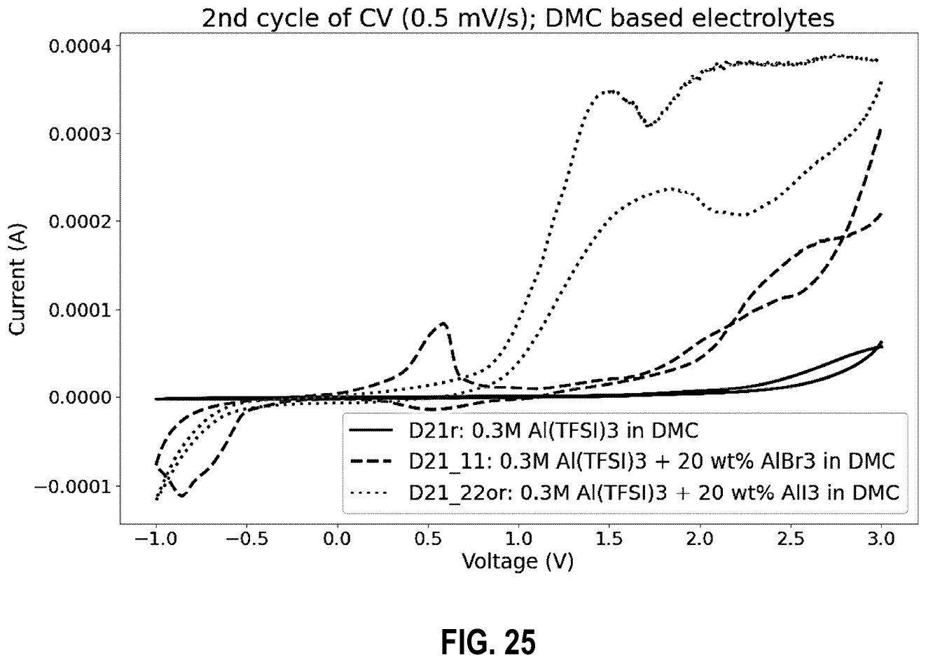

As shown in the example experiment of FIG. 25, 20 wt % AlBr₃ (D21_11) can promote aluminum plating, represented by the peak during the cathodic scan in a voltage range of −1 V to −0.5 V, and aluminum stripping, represented by the peak during the anodic scan at a voltage of ˜0.5 V. When adding AlI₃ as an additive (D21_22or) in this example, irreversibility is more prominent, the electrolyte is less stable, and SS corrosion is more evident when the voltage is above 0.5 V. This may be attributed to the relatively high reactivity of AlI₃ or DMC. Another possible reason can be the lower solubility of AlI₃ in DMC. Thus, the rapid current increase when the voltage is higher than 0.5 V may also be attributed to disturbance by the undissolved salts. Moreover, even though D21_22or is labeled as 0.3 M Al(TFSI)₃ in DMC, it may be Al(TFSI)₃ saturated solution, and the actual concentration of the solution may be lower than 0.3 M in some embodiments.

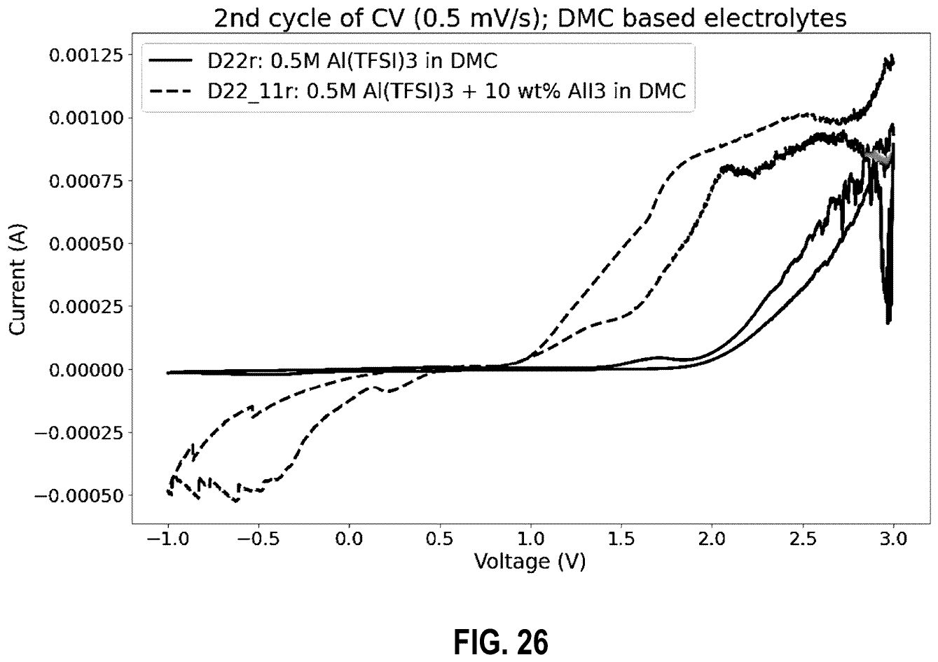

In some embodiments, AlI₃ can be added into 0.5 M Al(TFSI)₃ in DMC as an additive, as shown in the example experiment of FIG. 26. When adding AlI₃ as an additive (D22_11r) in this example, irreversibility is more prominent, the electrolyte is less stable, and SS corrosion is more evident when the voltage is above 0.9 V. This may be attributed to the relatively high reactivity of AlI₃ or DMC. Another possible reason can be the relatively low solubility of AlI₃ in DMC. Therefore, the rapid current increase when the voltage is higher than 0.9 V may also be attributed to disturbance by the undissolved salts. Moreover, even though D22r and D22_11r are labeled as 0.5 M Al(TFSI)₃ in DMC, they may be Al(TFSI)₃ saturated solutions, and the actual concentrations of the solutions may be lower than 0.5 M in some embodiments.

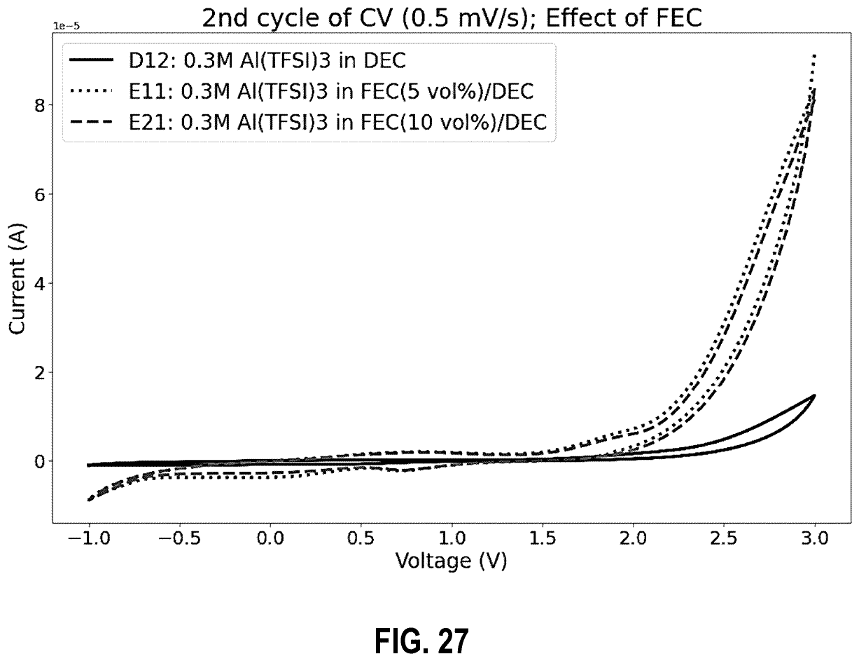

In some embodiments, a linear carbonate can be mixed with a cyclic carbonate to be used as an electrolyte solvent. As shown in the example experiment of FIG. 27, the increase of FEC concentration in the electrolyte facilitates aluminum plating and stripping, represented by the relatively small wave in a voltage range of −1 V to −0.5 V during the cathodic scan and the relatively small wave in a voltage range of 0.5 V to 1 V during the anodic scan, respectively. However, electrolytes having FEC in this example displayed evident electrolyte oxidation, SS corrosion, or both electrolyte oxidation and SS corrosion when voltage was higher than 1.5 V.

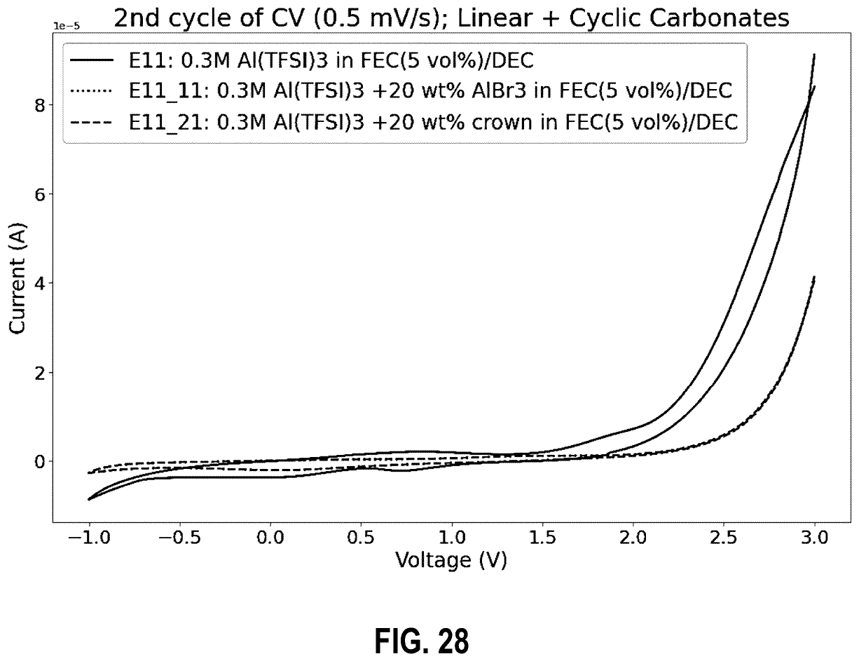

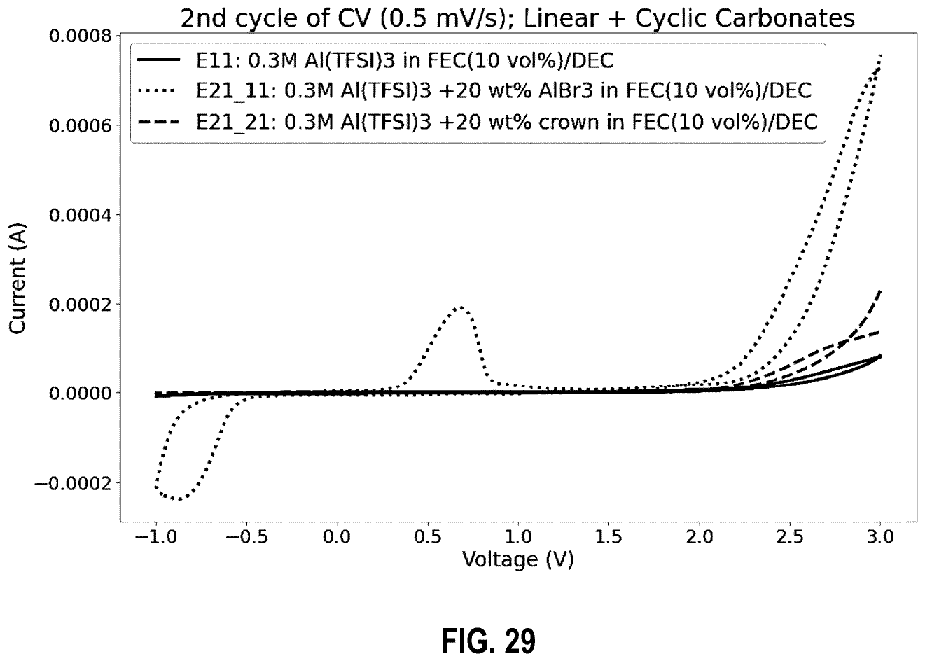

In some embodiments, one or more additives can be added into the Al(TFSI)₃ in FEC/DEC, as shown in the example experiment of FIG. 28. Adding 20 wt % AlBr₃ (E11_11) and 20 wt % crown (E11_21) into 0.3 M Al(TFSI)₃ in FEC(5 vol %)/DEC in this example facilitated suppression of electrolyte oxidation, SS corrosion, or both electrolyte oxidation and SS corrosion. However, aluminum plating was also suppressed. As shown in the example experiment of FIG. 29, adding 20 wt % AlBr₃ into 0.3 M Al(TFSI)₃ in FEC(10 vol %)/DEC (E21_11) promotes both aluminum plating, at a voltage range of −1 V to −0.5 V, and aluminum stripping, at a voltage range of 0.5 V to 1 V. Moreover, electrolyte oxidation, SS corrosion, or both electrolyte oxidation and SS corrosion were delayed to a voltage over 2 V in this example. However, adding 20 wt % crown in FEC(10 vol %)/DEC (E21_21) displays negligible difference compared to E11 in this example.

Electrolytes for MIBs can include Cl-free salts and Cl-free solvents. In some embodiments, the electrolytes further include one or more additives. During implementation in AIBs, one example representative Cl-free salt can be Al(TFSI)₃. One example representative Cl-free solvent can include a carbonate or a combination of multiple carbonates. The carbonate in some embodiments can be a linear carbonate, a cyclic carbonate, a mixture of linear carbonate and cyclic carbonate, etc. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ may have lower solubility in some solvents. The concentration in some embodiments, e.g., 0.3 M and 1 M, shall not be higher than the Al(TFSI)₃ concentration of a saturated solution. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. In some embodiments, the starting materials to synthesize Al(TFSI)₃ can either be Al foil or Al₂O₃ depending on the factors like production cost, purification requirements, and/or accessible equipment. When noisy signals appear, a 24-hour resting step may be performed in some embodiments to passivate the electrode surface prior to cycling. In some embodiments, the 24-hour resting step can be applied in cell testing as a preventive measure, even for the electrolytes that do not deliver noisy signals. Some example representative electrolytes, like 0.3 M Al(TFSI)₃+20 wt % AlBr₃ in FEC(5 vol %)/DEC, 0.3 M Al(TFSI)₃+20 wt % crown in FEC(5 vol %)/DEC, and 0.3 M Al(TFSI)₃+20 wt % AlBr₃ in FEC(10 vol %)/DEC, can have reversible aluminum plating/stripping demonstrated by symmetrical peaks in a range of −1 V to −0.5 V and in a range of 0.5 V to 1.5 V, respectively. Electrolyte oxidation, SS corrosion, or both electrolyte oxidation and SS corrosion did not happen until the voltage is ˜2 V in the representative electrolytes in some example experiments.

### Acetates

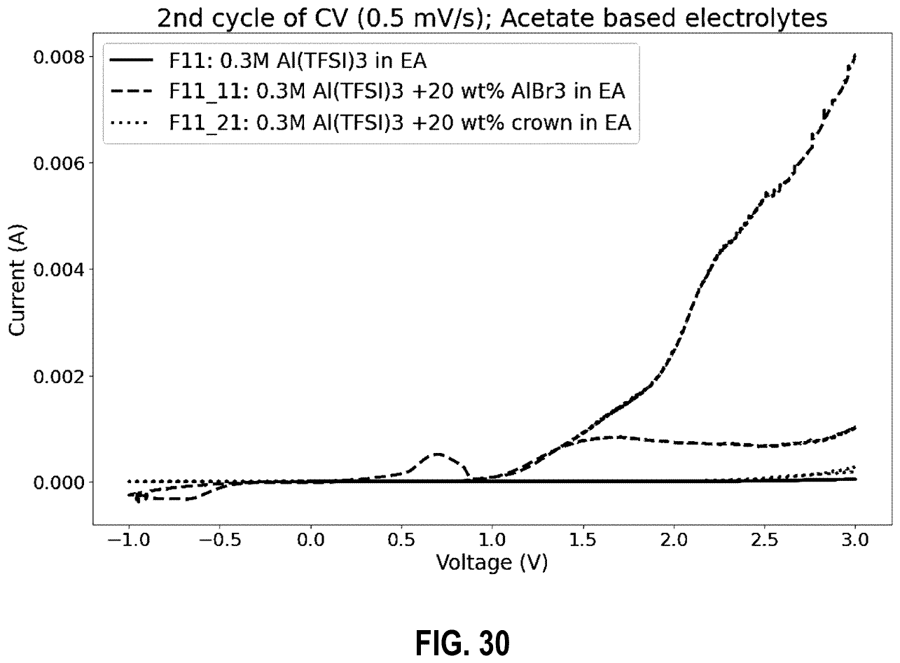

In some embodiments, acetates are used as electrolyte solvents. For example, when EA was used, as shown in the example experiment of FIG. 30, adding 20 wt % AlBr₃ into an electrolyte of 0.3 M Al(TFSI)₃ in EA (F11_11) promoted aluminum plating, represented by the peak during the cathodic scan in a voltage range of −1 V to −0.5 V, and aluminum stripping, represented by the peak during the anodic scan in a voltage range of 0.5 V to 1 V. However, when the voltage was higher than 1 V, F11_11, or 0.3 M Al(TFSI)₃+20 wt % AlBr₃ in EA, exhibits electrolyte oxidation, SS corrosion, or both electrolyte oxidation and SS corrosion in this example. This may be attributed to the relatively high reactivity of EA. Another possible reason can be the relatively lower solubility of AlBr₃ in EA. Thus, the rapid current increase when the voltage is higher than 1 V in this example may also be attributed to disturbance by the undissolved salts. Moreover, even though F11_11 is labeled as 0.3 M Al(TFSI)₃ in EA, it may be an Al(TFSI)₃ saturated solution, and the actual concentration of the solution may be lower than 0.3 M in some embodiments. However, adding 20 wt % crown in EA (F11_21) displays negligible difference compared to F11 in this example.

Electrolytes for MIBs can include Cl-free salts and Cl-free solvents. In some embodiments, the electrolytes further include one or more additives. During implementation in AIBs, in some embodiments one example representative Cl-free salt can be Al(TFSI)₃. One example representative Cl-free solvent can include an acetate or a combination of multiple acetates. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ has lower solubility in some solvents. The concentration of certain embodiments, e.g., 0.3 M and 1 M, shall not be higher than the Al(TFSI)₃ concentration of the saturated solution. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. Some example representative electrolytes, like 0.3 M Al(TFSI)₃+20 wt % AlBr₃ in EA, can have excellent reversible aluminum plating/stripping, which can be demonstrated in some experiments by symmetrical peaks in a range of −1 V to −0.5 V and in a range of 0.5 V to 1 V, respectively.

### Organosulfurs

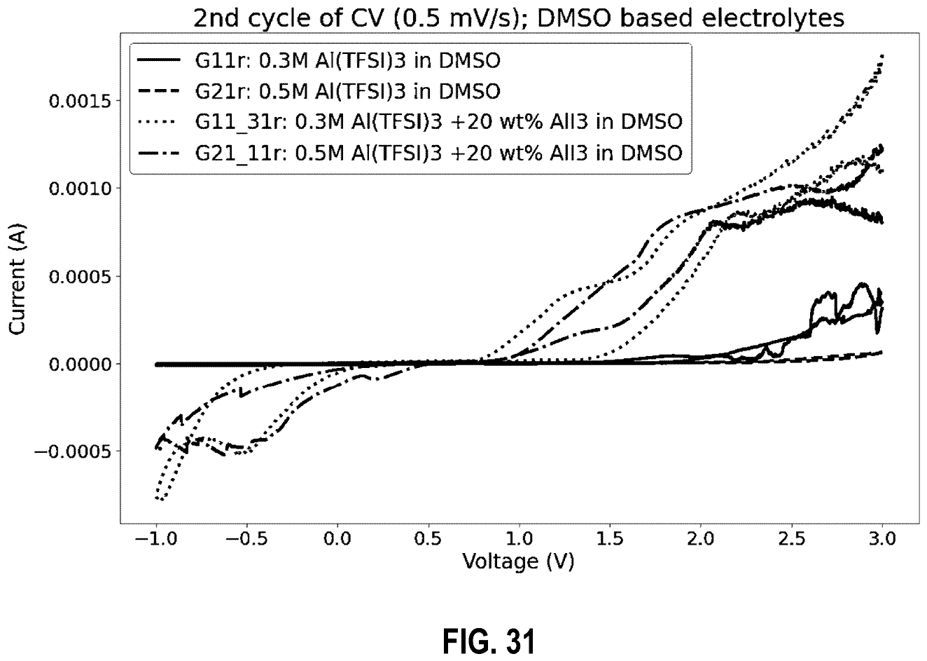

In some embodiments, organosulfurs are used as electrolyte solvents. For example, in the example experiment of FIG. 31, DMSO was used as the electrolyte solvent, and electrolytes with Al(TFSI)₃ in DMSO without additives (G11r and G21r) do not appear to display aluminum plating while electrolyte oxidation, SS corrosion, or both electrolyte oxidation and SS corrosion can be seen. After adding additives (G11_31r and G21_11r), in this example aluminum plating was evident at ˜−0.5 V. However, aluminum stripping in G11_31r was either negligible or pushed to >1.2 V in this example. When the Al(TFSI)₃ concentration was increased to 0.5 M while keeping 20 wt % AlI₃ in DMSO, the aluminum stripping, G21_11r in this example, was either negligible or pushed to >1.5 V. Thus, by adding additives, in this example irreversibility was more prominent, electrolyte was less stable, and SS corrosion was more evident. The curves in this example are similar even for the noisy parts, regardless of the Al(TFSI)₃ concentration in DMSO. This may be attributed to the fact that Al(TFSI)₃ can have relatively low solubility in DMSO or the relatively high reactivity of DMSO. The noisy curves may be attributed to disturbance by the undissolved salts or the relatively high reactivity of DMSO. Even though G11r and G11_31r are labeled as 0.3 M Al(TFSI)₃ in DMSO, they may be Al(TFSI)₃ saturated solutions and the actual concentrations of the solutions may be lower than 0.3 M in some embodiments. Another possible reason may be the relatively high reactivity of DMSO. All curves in the example experiment of FIG. 31 were obtained by adding a 24-hour resting step prior to cycling, and the noisy signals were reduced but still exist.

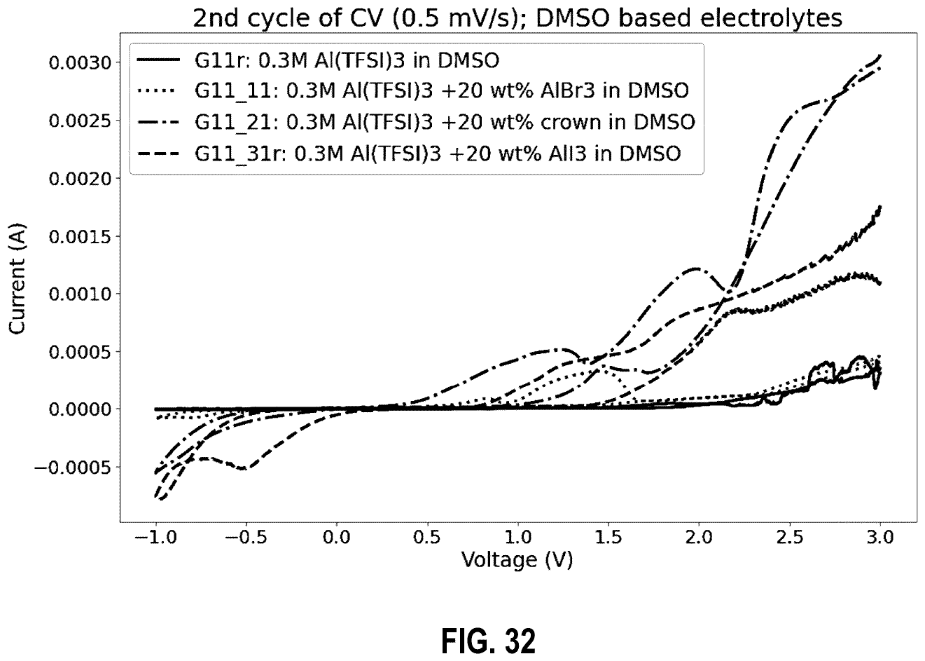

Referring to the example experiment of FIG. 32, when various additives were added to the electrolyte of 0.3 M Al(TFSI)₃ in DMSO, adding 20 wt % AlBr₃ (G11_11) promoted aluminum plating, in a voltage range of −1 V to −0.5 V, and aluminum stripping, in a voltage range of 0.5 V to 1 V. There was also a peak at −1.5 V in G11_11 in this example, which may be attributed to electrolyte oxidation, SS corrosion, or both electrolyte oxidation and SS corrosion. Additives including AlI₃ (G11_31r) and crown (G11_21), in this example also enhanced the aluminum plating at a voltage of ˜−0.5 V. However, the aluminum stripping in this example was either negligible or pushed to a voltage of >1 V. Together with the peaks over 1.5 V, it can indicate that irreversibility, electrolyte oxidation, or SS corrosion are prominent in this example when adding additives like crown and AlI₃.

Electrolytes for MIBs can include Cl-free salts and Cl-free solvents. In some embodiments, the electrolytes further include one or more additives. During implementation in AIBs in some embodiments, one example representative Cl-free salt can be Al(TFSI)₃. One representative Cl-free solvent can include an organosulfur or a combination of multiple organosulfurs. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ has lower solubility in some solvents. The concentration in some embodiments, e.g., 0.3 M and 1 M, shall not be higher than the Al(TFSI)₃ concentration of a saturated solution. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. When noisy signals appear, in some examples it may be desirable to include a 24-hour resting step to passivate the electrode surface prior to cycling. In some embodiments, the 24-hour resting step can be applied in cell testing as a preventive measure, even for the electrolytes that do not deliver noisy signals. Some example representative electrolytes, like 0.3 M Al(TFSI)₃+20 wt % AlBr₃ in DMSO, can have reversible aluminum plating/stripping demonstrated by symmetrical peaks in a range of −1 V to −0.5 V and in a range of 0.5 V to 1 V, respectively, in some experiments.

### Amides

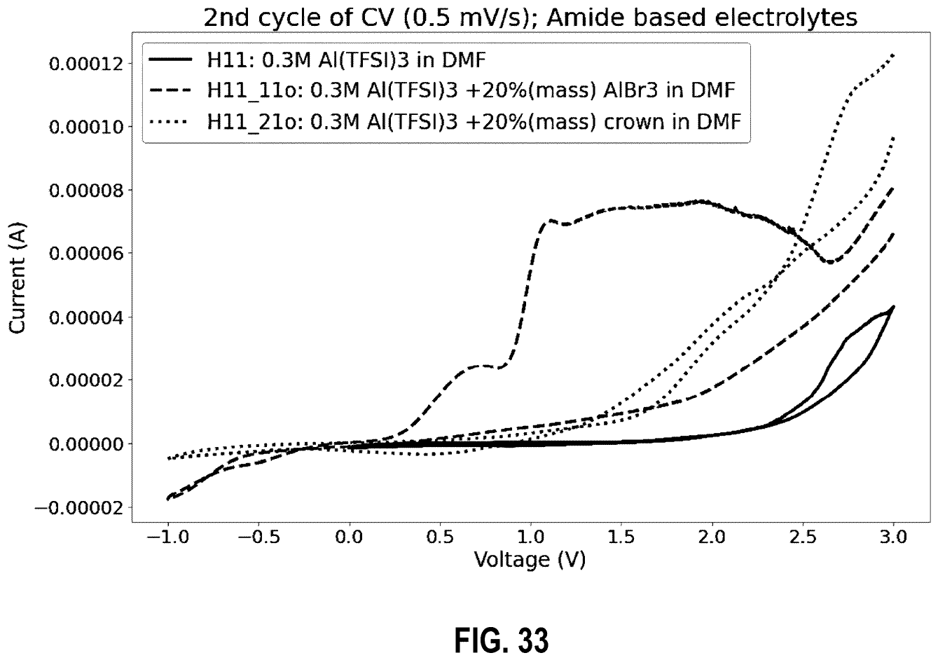

In some embodiments, amides are used as electrolyte solvents. For example, when DMF was used, as shown in the example experiment of FIG. 33, adding 20 wt % AlBr₃ into 0.3 M Al(TFSI)₃ in DMF (H11_11o) promoted aluminum plating, at a voltage of ˜−0.5 V, and aluminum stripping, at a voltage of ˜0.5 V. However, when the voltage was higher than 0.8 V in this example, H11_11o displayed a current plateau, which may be attributed to electrolyte oxidation, SS corrosion, or both electrolyte oxidation and SS corrosion. When crown was added (H11_21o) or no additive was added (H11), in this example the aluminum plating was negligible. However, the aluminum stripping was also suppressed in both H11 and H11_21o in this example, while electrolyte oxidation, SS corrosion, or both electrolyte oxidation and SS corrosion are prominent in H11_21o. In H11_11o and H11_21o, Al₂O₃ was used in this example to synthesize Al(TFSI)₃ instead of Al foil to demonstrate alternative synthesis pathways.

Electrolytes for MIBs can include Cl-free salts and Cl-free solvents. In some embodiments, the electrolytes can further include one or more additives. During implementation in AIBs in some embodiments, one example representative Cl-free salt can be Al(TFSI)₃. One example representative Cl-free solvent can include an amide or a combination of multiple amides. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ may have lower solubility in some solvents. The concentration in some embodiments, e.g., 0.3 M and 1 M, shall not be higher than the Al(TFSI)₃ concentration of a saturated solution. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. In some embodiments, the starting materials to synthesize Al(TFSI)₃ can either be Al foil or Al₂O₃ depending on factors like production cost, purification requirements, and/or accessible equipment. Some example representative electrolytes, like 0.3 M Al(TFSI)₃+20 wt % AlBr₃ in DMF, can show reversible aluminum plating/stripping behaviors in some embodiments, which may be demonstrated in some examples by symmetrical peaks in a range of −1 V to −0.5 V and in a range of 0.5 V to 1 V, respectively.

### Nitriles

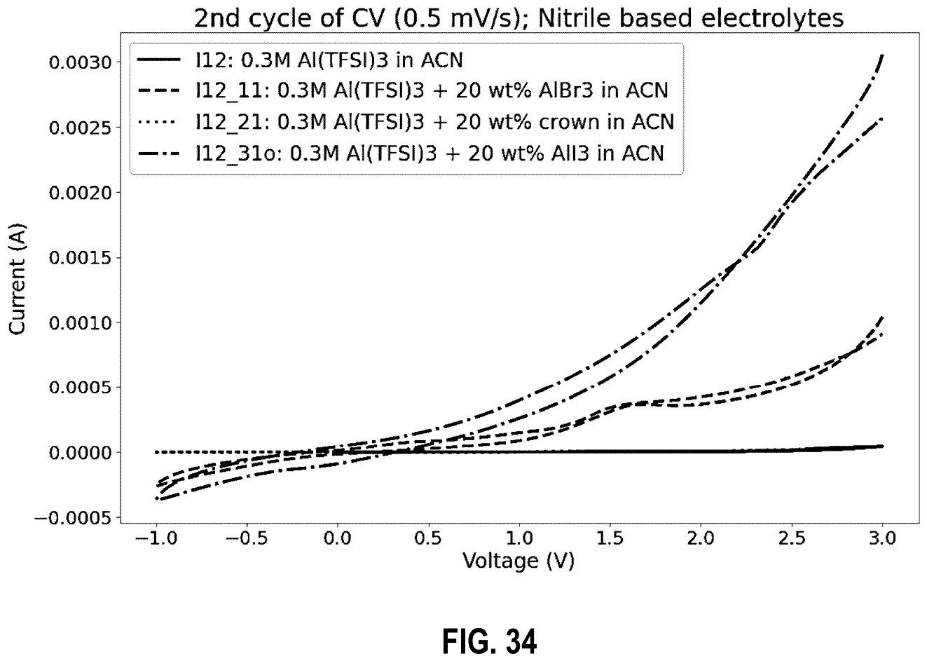

In some embodiments, nitriles can be used as electrolyte solvents. For example, when ACN is used in some embodiments, such as shown in the example experiment of FIG. 34, adding 20 wt % AlBr₃ (I12_11) and AlI₃ (I12_31o) into 0.3 M Al(TFSI)₃ in ACN facilitated aluminum plating, represented by relatively small waves in a voltage range from −1 V to −0.5 V. However, aluminum stripping did not seem to be observed or was irreversibly delayed to a voltage of ˜1.5 V. Moreover, electrolyte oxidation, SS corrosion, or both electrolyte oxidation and SS corrosion were prominently represented in this example by current increase when the voltage was >1.5 V for I12_11. Adding AlI₃ in this example resulted in continuous (e.g., uninterrupted) current increase when the voltage was >0.5 V, indicating that a voltage of 0.5 V was the onset of electrolyte oxidation, SS corrosion, or both electrolyte oxidation and SS corrosion for I12_31o. When adding crown as an additive (I12_21) or no additive (I12) to CAN-based electrolytes, in this example aluminum plating and stripping were negligible. Electrolyte oxidation, SS corrosion, or both electrolyte oxidation and SS corrosion were also negligible in this example. For I12_31o, Al₂O₃ was used to synthesize Al(TFSI)₃ instead of Al foil to demonstrate alternative synthesis pathways in this example.

Electrolytes for MIBs can include Cl-free salts and Cl-free solvents. In some embodiments, the electrolytes further include one or more additives. During implementation in AIBs in some embodiments, one example representative Cl-free salt can be Al(TFSI)₃. One example representative Cl-free solvent can include a nitrile or a combination of multiple nitriles. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. In some embodiments, the starting materials to synthesize Al(TFSI)₃ can either be Al foil or Al₂O₃ depending on factors like production cost, purification requirements, and/or accessible equipment. Some example representative electrolytes, like 0.3 M Al(TFSI)₃+20 wt % AlBr₃ in ACN, can have acceptable aluminum plating/stripping demonstrated by peaks in a range of −1 V to −0.5 V or ˜1.5 V, respectively, in some example experiments.

### Pyrrolidones

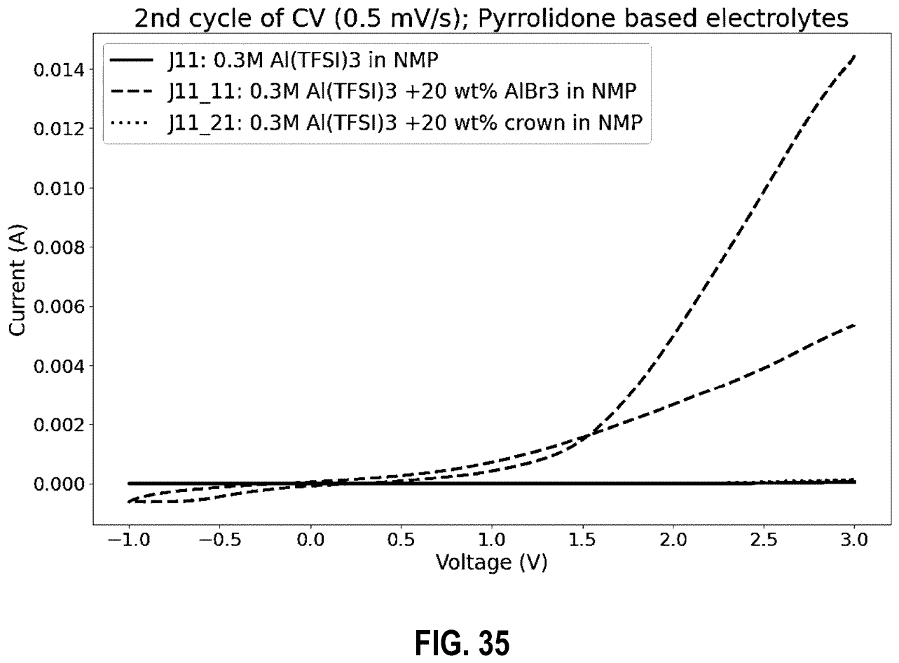

In some embodiments, pyrrolidones are used as electrolyte solvents. For example, in some examples when NMP is used, such as shown in the example experiment of FIG. 35, adding 20 wt % AlBr₃ into 0.3 M Al(TFSI)₃ in NMP (J11_11) promoted aluminum plating, in a voltage range of −1 V to −0.5 V, and aluminum stripping, in a voltage range of 0.5 V to 1 V. However, when the voltage was higher than 1 V, 0.3 M Al(TFSI)₃+20 wt % AlBr₃ in NMP in this example also showed electrolyte oxidation, SS corrosion, or both electrolyte oxidation and SS corrosion. Adding 20 wt % crown in NMP (J11_21) displayed negligible difference compared to J11 in this example.

Electrolytes for MIBs can include Cl-free salts and Cl-free solvents. In some embodiments, the electrolytes further include one or more additives. During implementation in AIBs in some embodiments, one example representative Cl-free salt can be Al(TFSI)₃. One example representative Cl-free solvent can include a pyrrolidone or a combination of multiple pyrrolidones. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. Some representative electrolytes, like 0.3 M Al(TFSI)₃+20 wt % AlBr₃ in NMP, can have acceptable aluminum plating/stripping in some embodiments, which can be demonstrated by peaks in a voltage range of −1 V to −0.5 V and in a voltage range of 1 V to 1.5 V, respectively, in some example experiments.

### Pyridine

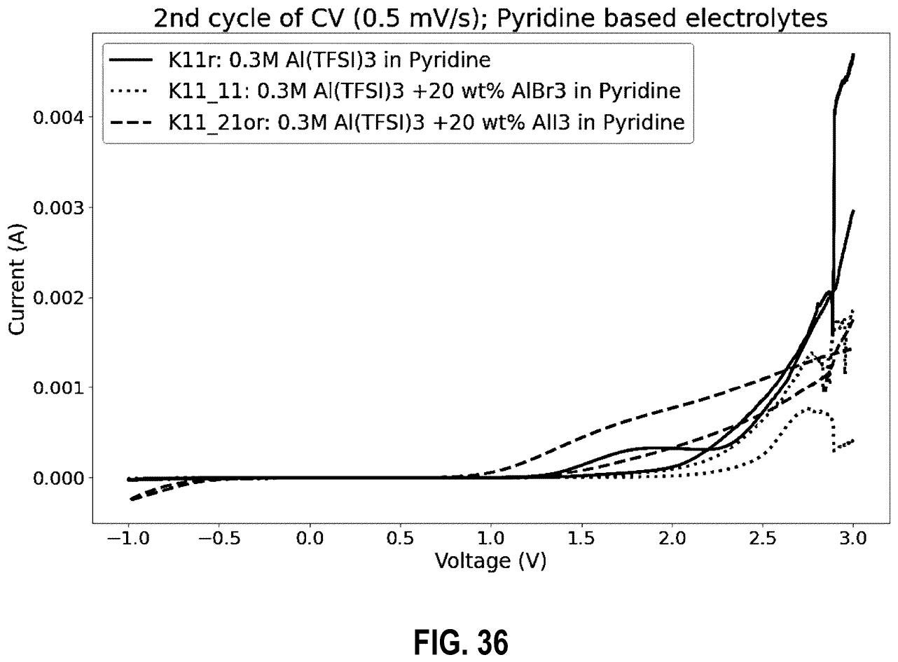

In some embodiments, pyridine can be used as the electrolyte solvent. As shown in the example experiment of FIG. 36, when pyridine was used as the electrolyte solvent, adding AlI₃ as an additive into the electrolyte of 0.3 M Al(TFSI)₃ in pyridine (K11_21or) promoted aluminum plating, represented by the current increase during the cathodic scan when the voltage is <−0.5 V. In addition, aluminum stripping was also enhanced in this example, represented by the current increase during the anodic scan when the voltage is >1 V. However, the continuous (e.g., uninterrupted) current rise when the voltage is higher than 1 V in this example may make it challenging to distinguish the aluminum stripping from electrolyte oxidation, SS corrosion, or both electrolyte oxidation and SS corrosion. Adding 20 wt % AlBr₃ into the electrolyte of 0.3 M Al(TFSI)₃ in pyridine (K11_11) in this example displayed negligible impacts on aluminum plating compared to the electrolyte of 0.3 M Al(TFSI)₃ in pyridine (K11r). However, the aluminum stripping, electrolyte oxidation, SS corrosion, or both electrolyte oxidation and SS corrosion were suppressed in this example by adding AlBr₃. Moreover, noisy signals were observable in both K11r and K11_11 in this example. One possible reason can be the relatively high reactivity of pyridine. Another possible reason can be the relatively low solubility of Al(TFSI)₃ in pyridine and the undissolved salts disturbing the testing environment, leading to noisy signals. Moreover, even though K11r, K11_11, and K11_21or are labeled as 0.3 M Al(TFSI)₃ in pyridine, they may be Al(TFSI)₃ saturated solutions in some embodiments, and the actual concentrations of the solutions may be lower than 0.3 M in some embodiments.

In some embodiments, the relatively high reactivity of pyridine and the relatively low solubility of Al(TFSI)₃ in pyridine may result in noisy signals. Thus, a 24-hour resting step can be added (K11r and K11_21or) prior to cycling to minimize the noisy signals. In K11_21or, Al₂O₃ was used to synthesize Al(TFSI)₃ instead of Al foil to demonstrate alternative synthesis pathways in this example.

Electrolytes for MIBs can include Cl-free salts and Cl-free solvents. In some embodiments, the electrolytes further include one or more additives. During implementation in AIBs in some embodiments, one example representative Cl-free salt can be Al(TFSI)₃. One example representative Cl-free solvent can include a pyridine or a combination of multiple pyridines. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 1 M. In some embodiments, Al(TFSI)₃ has lower solubility in some solvents. The concentration, e.g., 0.3 M and 1 M in some embodiments, shall not be higher than the concentration of a saturated solution of Al(TFSI)₃ in a corresponding solvent. In some embodiments, the one or more additives can include inorganic species, such as halides, and/or organic compounds, such as crown. Additive concentration in some examples can be in a range from 5 wt % to 40 wt %. In additional or alternative examples, the additive concentration can be in a range from 5 wt % to 30 wt %. In additional or alternative examples, the additive concentration can be in a range from 10 wt % to 20 wt %. In some embodiments, the starting materials to synthesize Al(TFSI)₃ can either be Al foil or Al₂O₃ depending on factors like production cost, purification requirements, and/or accessible equipment. When noisy signals appear, it may be desirable to include a 24-hour resting step to passivate the electrode surface prior to cycling. In some embodiments, such a 24-hour resting step can be applied in cell testing as a preventive measure, even for the electrolytes that do not deliver noisy signals.

Electrolyte Salts Other than Al(TFSI)₃

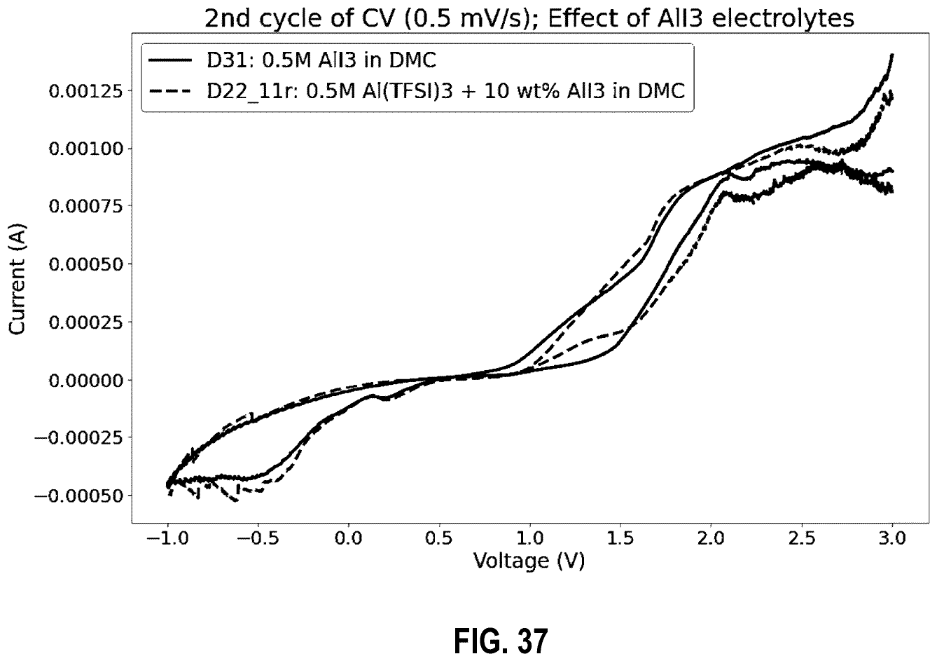

In some embodiments, when implementing the synthetic methods presented in FIGS. 1-3, other Lewis acids can be used to synthesize the electrolyte salts. For example, AlI₃ can be synthesized following the steps of process 100 of FIG. 1. Electrolytes having AlI₃ as a salt may or may not utilize additives in some embodiments, depending on the actual needs during application. As shown in the example experiment of FIG. 37, the electrolyte of 0.5 M AlI₃ in DMC (D31) promoted aluminum plating, represented by the current increase during the cathodic scan at a voltage of ˜−0.5 V. In addition, aluminum stripping was also enhanced in this example, represented by the current increase during the anodic scan when the voltage is between 1 V and 1.7 V. However, the continuous (e.g., uninterrupted) current rise when the voltage was higher than 1.8 V demonstrated significant electrolyte oxidation, SS corrosion, or both electrolyte oxidation and SS corrosion in this example. Thus, using AlI₃ as the electrolyte salt (D31) or electrolyte additive (D22_11) in this example promoted both aluminum plating and stripping. Moreover, noisy signals are observable in both D31 and D22_11 in this example. One possible reason can be the relatively high reactivity of AlI₃ or DMC. Another possible reason can be the relatively low solubility of AlI₃ in DMC, and the undissolved salts disturbing the testing environment, leading to noisy signals. Moreover, even though D31 is labeled as 0.5 M AlI₃ in DMC, it may be an AlI₃ saturated solution in some embodiments, and the actual concentration of the solution may be lower than 0.5 M in some embodiments.

TABLE 4
Example representative electrolytes
using AlI₃ as the electrolyte salt

| Solvent category | Code | AlI₃ concentration | Solvent |
|---|---|---|---|
| Carbonates | D31 | 0.5M | DMC |
| Organosulfurs | G31r | 0.5M | DMSO |
| | G32 | 0.3M | |
| | G33 | 0.1M | |

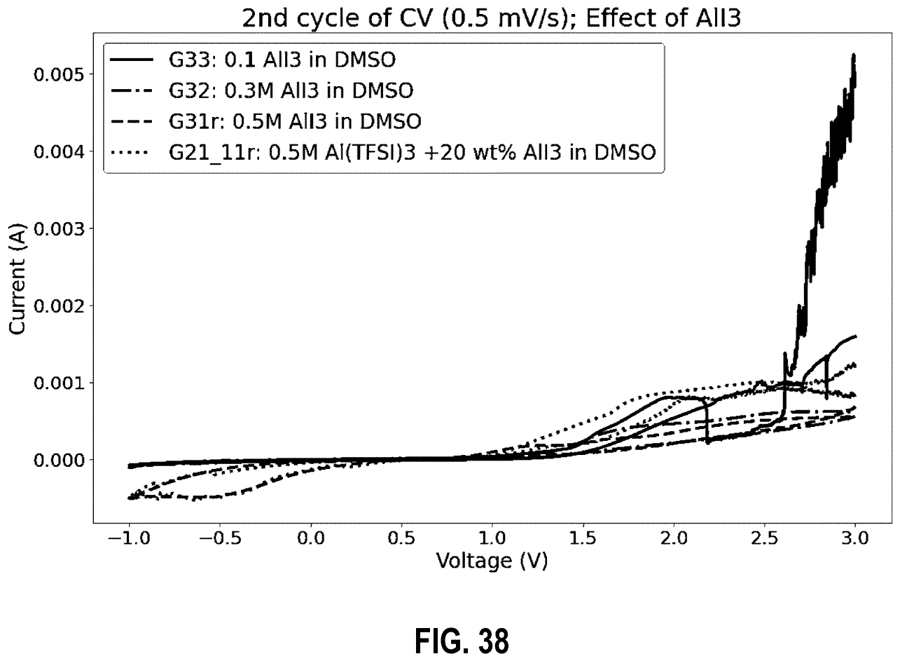

In some embodiments, AlI₃ in DMSO can be used as an electrolyte. As shown in the example experiment of FIG. 38, using AlI₃ as the electrolyte salt (G31r) or electrolyte additive (G21_11r) displayed similar aluminum plating demonstrated by the similar curves during cathodic scans. However, significant electrolyte oxidation, SS corrosion, or both electrolyte oxidation and SS corrosion are more apparent in G31r than G21_11r in this example. This may be attributed to the relatively high reactivity of AlI₃ or DMSO. Another possible reason may be the relatively low solubility of AlI₃ in DMSO, and/or the undissolved salts disturbing the testing environment, leading to noisy signals. Moreover, even though G31r is labeled as 0.5 M AlI₃ in DMSO, in some embodiments it may be an AlI₃ saturated solution, and the actual concentration of the solution may be lower than 0.5 M in some embodiments. When reducing the AlI₃ concentration in DMSO, aluminum plating in this example was negligible in both 0.1 M AlI₃ (G33) and 0.3 M AlI₃ (G32) electrolytes. However, the low AlI₃ concentration (G33) was detrimental to cell reversibility in this example, though the electrolyte was stable, and SS corrosion resistance was demonstrated by the noisy signals over 2.2 V.

Electrolytes for MIBs can include Cl-free salts and Cl-free solvents. In some embodiments, the electrolytes may further include one or more additives. During implementation in AIBs in some embodiments, one example representative Cl-free salt can be AlI₃. One example representative Cl-free solvent can include DMC or DMSO. The Cl-free salt concentration in some examples can be in a range from 0 to the concentration of a saturated solution. In additional or alternative examples, the Cl-free salt concentration can be in a range from 0 to 1 M. In additional or alternative examples, the Cl-free salt concentration can be in a range from 0.3 M to 0.5 M. In some embodiments, AlI₃ has lower solubility in some solvents. The concentration, e.g., 0.3 M and 1 M, shall not be higher than the concentration of saturated solution of AlI₃ in a corresponding solvent in some embodiments. When noisy signals appear, in some embodiments it may be desirable to include a 24-hour resting step to passivate the electrode surface prior to cycling. In some embodiments, the 24-hour resting step can be applied in cell testing as a preventive measure, even for the electrolytes that do not deliver noisy signals. Some example representative electrolytes, like 0.5 M AlI₃ in DMC and 0.5 M AlI₃ in DMSO, can have acceptable aluminum plating/stripping in some embodiments, which can be demonstrated by a wave at a voltage of ˜−0.5 V and in a voltage range of 1 V to 1.7 V, respectively, in some example experiments.

### Additional Characteristics of the Electrolytes of Some Embodiments

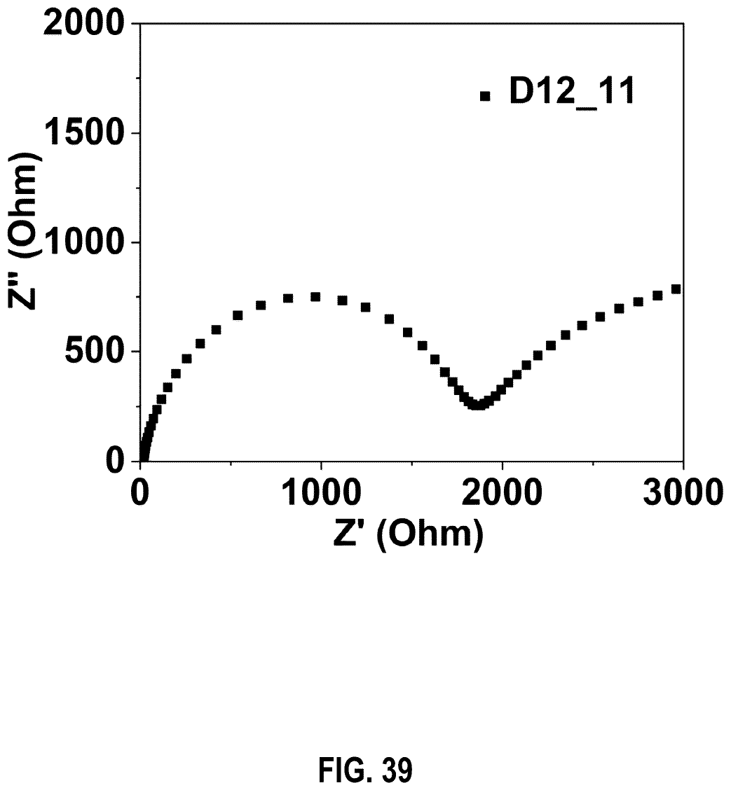

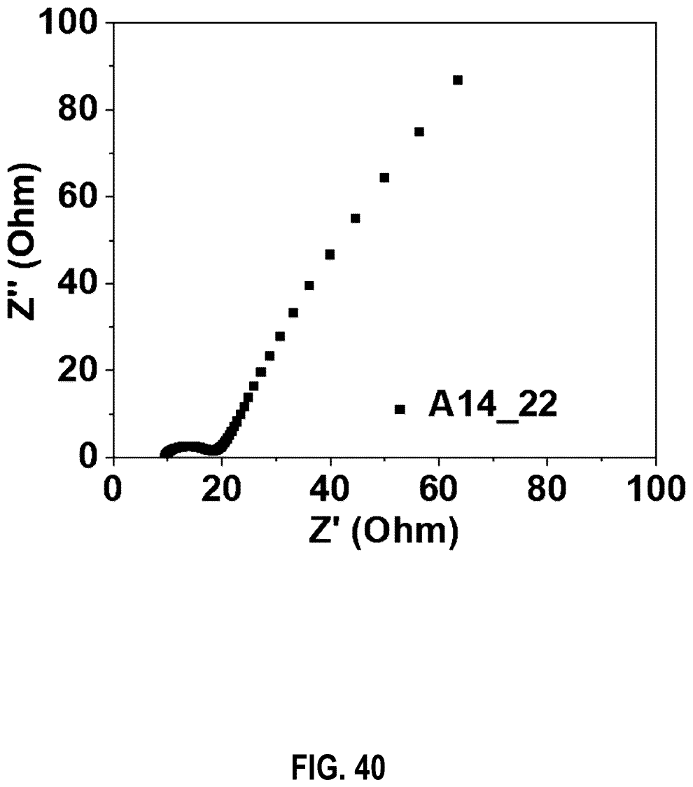

In some embodiments, the liquid electrolytes display an ionic conductivity in a range of 1×10⁻⁵-1×10⁻² S/cm. In additional or alternative embodiments, the ionic conductivity can be in a range of 1×10⁻³-1×10⁻² S/cm. As shown in the example experiments of FIGS. 39 and 40, 0.3 M Al(TFSI)₃+20 wt % AlBr₃ in DEC (D12_11) showed a solution resistance Rₛ of 15Ω, while 0.3 M Al(TFSI)₃+20 wt % AlBr₃ in DME (A14_22) showed a solution resistance Rₛ of 8.5Ω. The ionic conductivity, σ, was calculated using:

$$σ = \frac{L}{R \cdot A} \qquad ( 1 )$$

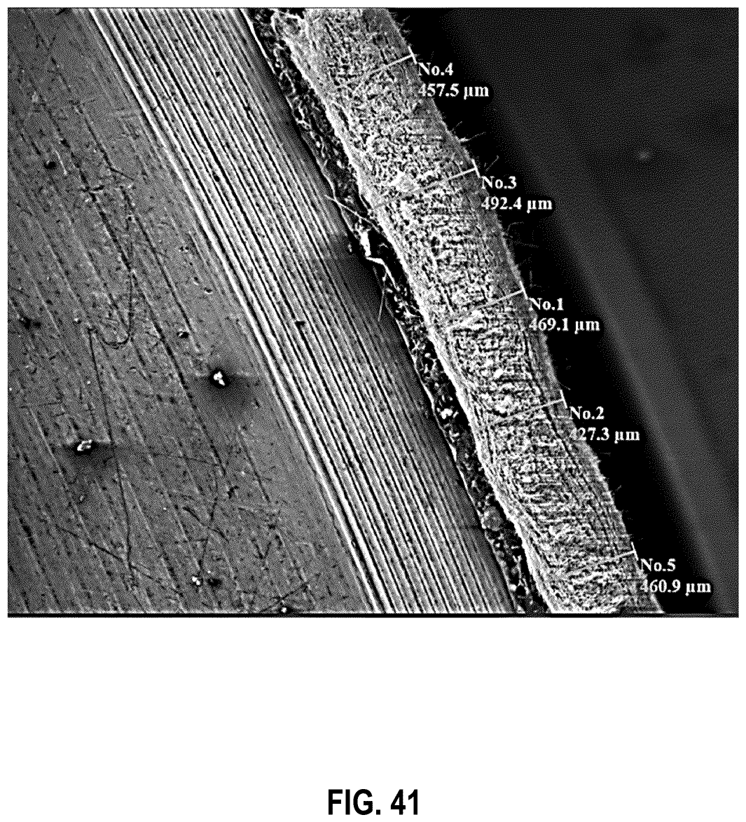

L is the thickness of the separator, as illustrated in the example experiment of FIG. 41, which was around 461 μm in this example. A is the area of the electrode. When R is represented by Rₛ, the range of ionic conductivity was 3.8×10⁻³-6.9×10⁻³ S/cm. When R is represented by a sum of solution resistance (Rₛ), bulk resistance (R_{b}), and charge transfer resistance (R_{ct}), the range of ionic conductivity was 3.2×10⁻⁵-2.9×10⁻³ S/cm. Ionic conductivities of the electrolytes in some examples can be in a range of 1×10⁻⁵-1×10⁻² S/cm. In additional or alternative examples, the ionic conductivities can be in a range of 1×10⁻³-1×10⁻² S/cm. In additional or alternative examples, the ionic conductivities can be in a range of 2.9×10⁻³-6.9×10⁻³ S/cm.

The specification and drawings are to be regarded in an illustrative rather than a restrictive sense. It will, however, be evident that various modifications and changes may be made thereunto without departing from the broader spirit and scope of the invention as set forth in the claims. That is, the described embodiments are susceptible to various modifications and alternative forms, and specific examples thereof have been shown by way of example in the drawings and are herein described in detail.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

Embodiments of the present disclosure can be described in view of the following clauses:

1. An electrolyte composition, comprising:
a solvent; and
a salt comprising Al(TFSI)₃ at least partially dissolved in the solvent at a concentration of 0.3 M to 1 M,
wherein the electrolyte composition is free of chlorine ions.

2. The electrolyte composition of clause 1, further comprising:
one or more additives at least partially dissolved in the solvent at a concentration of 5 wt % to 30 wt %.

3. The electrolyte composition of clause 2, wherein the one or more additives comprise a halide.

4. The electrolyte composition of clause 3, wherein the halide comprises AlBr₃ or AlI₃.

5. The electrolyte composition of any one of clauses 2-4, wherein the one or more additives comprise crown.

6. The electrolyte composition of any one of clauses 1-5, wherein the solvent comprises an ether, a carbonate, an acetate, an organosulfur, an amide, a nitrile, a pyrrolidone, or a pyridine.

7. The electrolyte composition of any one of clauses 1-6, wherein an ionic conductivity of the electrolyte composition is in a range of 1×10⁻³ S/cm to 1×10⁻² S/cm.

8. A method for forming an electrolyte composition, the method comprising:
performing a surface treatment of Al foil;
performing a neutralization reaction of the surface-treated Al foil with a Lewis acid at a temperature between 90° C. and 100° C. to generate a product powder;
dehydrating the product powder to obtain an electrolyte salt; and
dissolving the electrolyte salt in a solvent until a solution having a target concentration of the electrolyte salt is formed, wherein the target concentration of the electrolyte salt is between 0.3 M and 1 M and wherein the solution is free of chlorine ions.

9. The method of clause 8, further comprising:
dissolving one or more additives in the solution at a concentration of 5 wt % to 30 wt %.

10. The method of clause 9, wherein the one or more additives comprise a halide.

11. The method of any one of clauses 9 or 10, wherein the one or more additives comprise crown.

12. The method of any one of clauses 8-11, wherein the surface treatment comprises mechanical polishing and/or chemical etching.

13. The method of any one of clauses 8-12, wherein the surface treatment reduces an amount of surface oxides on the Al foil and increases a surface area of the Al foil.

14. The method of any one of clauses 8-13, wherein the electrolyte salt comprises Al(TFSI)₃.

15. The method of any one of clauses 8-14, wherein the electrolyte salt comprises AlI₃.

16. The method of any one of clauses 8-15, wherein the solvent comprises an ether, a carbonate, an acetate, an organosulfur, an amide, a nitrile, a pyrrolidone, or a pyridine.

17. An aluminum-based secondary battery system, comprising:
a cell stack, comprising:
   a stainless steel cathode;
   an Al foil anode;
   a separator interposed between the stainless steel cathode and the Al foil anode; and
   an electrolyte composition fluidly coupling the stainless steel cathode and the Al foil anode across the separator, the electrolyte composition comprising:
      a solvent; and
      an Al salt at least partially dissolved in the solvent at a concentration of 0.3 M to 1 M,
      wherein the electrolyte composition is free of chlorine; and
a casing enclosing the cell stack.

18. The aluminum-based secondary battery system of clause 17, wherein the Al salt comprises AlI₃, Al(FSI)₃, or Al(TFSI)₃.

19. The aluminum-based secondary battery system of any one of clauses 17 or 18, wherein the solvent comprises an ether, a carbonate, an acetate, an organosulfur, an amide, a nitrile, a pyrrolidone, or a pyridine.

20. The aluminum-based secondary battery system of any one of clauses 17-19, wherein the electrolyte composition further comprises one or more additives at least partially dissolved in the solvent at a concentration of 5 wt % to 30 wt %, the one or more additives comprising a halide or crown.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. An electrolyte composition, comprising:
a solvent; and
a salt comprising Al(TFSI)₃ at least partially dissolved in the solvent at a concentration of 0.3 M to 1 M,
wherein the electrolyte composition is free of chlorine ions.

2. The electrolyte composition of claim 1, further comprising:
one or more additives at least partially dissolved in the solvent at a concentration of 5 wt % to 30 wt %.

3. The electrolyte composition of claim 2, wherein the one or more additives comprise a halide.

4. The electrolyte composition of claim 3, wherein the halide comprises AlBr₃ or AlI₃.

5. The electrolyte composition of claim 2, wherein the one or more additives comprise crown.

6. The electrolyte composition of claim 1, wherein the solvent comprises an ether, a carbonate, an acetate, an organosulfur, an amide, a nitrile, a pyrrolidone, or a pyridine.

7. The electrolyte composition of claim 1, wherein an ionic conductivity of the electrolyte composition is in a range of 1×10⁻³ S/cm to 1×10⁻² S/cm.

8. A method for forming an electrolyte composition, the method comprising:
performing a surface treatment of Al foil;
performing a neutralization reaction of the surface-treated Al foil with a Lewis acid at a temperature between 90° C. and 100° C. to generate a product powder;
dehydrating the product powder to obtain an electrolyte salt; and
dissolving the electrolyte salt in a solvent until a solution having a target concentration of the electrolyte salt is formed, wherein the target concentration of the electrolyte salt is between 0.3 M and 1 M and wherein the solution is free of chlorine ions.

9. The method of claim 8, further comprising:
dissolving one or more additives in the solution at a concentration of 5 wt % to 30 wt %.

10. The method of claim 9, wherein the one or more additives comprise a halide.

11. The method of claim 9, wherein the one or more additives comprise crown.

12. The method of claim 8, wherein the surface treatment comprises mechanical polishing and/or chemical etching.

13. The method of claim 8, wherein the surface treatment reduces an amount of surface oxides on the Al foil and increases a surface area of the Al foil.

14. The method of claim 8, wherein the electrolyte salt comprises Al(TFSI)₃.

15. The method of claim 8, wherein the electrolyte salt comprises AlI₃.

16. The method of claim 8, wherein the solvent comprises an ether, a carbonate, an acetate, an organosulfur, an amide, a nitrile, a pyrrolidone, or a pyridine.

17. An aluminum-based secondary battery system, comprising:
a cell stack, comprising:
a stainless steel cathode;
an Al foil anode;
a separator interposed between the stainless steel cathode and the Al foil anode; and
an electrolyte composition fluidly coupling the stainless steel cathode and the Al foil anode across the separator, the electrolyte composition comprising:
a solvent; and
an Al salt at least partially dissolved in the solvent at a concentration of 0.3 M to 1 M,
wherein the electrolyte composition is free of chlorine; and
a casing enclosing the cell stack.

18. The aluminum-based secondary battery system of claim 17, wherein the Al salt comprises AlI₃, Al(FSI)₃, or Al(TFSI)₃.

19. The aluminum-based secondary battery system of claim 17, wherein the solvent comprises an ether, a carbonate, an acetate, an organosulfur, an amide, a nitrile, a pyrrolidone, or a pyridine.

20. The aluminum-based secondary battery system of claim 17, wherein the electrolyte composition further comprises one or more additives at least partially dissolved in the solvent at a concentration of 5 wt % to 30 wt %, the one or more additives comprising a halide or crown.
